(19) United States
(12) Patent Application Publication
(10) Pub. No.: US 2011/0020637 A1
(43) Pub. Date: Jan. 27, 2011

(54) LAMINATED FILM AND PRESSURE-SENSITIVE ADHESIVE TAPE

(75) Inventors: Shinsuke IKISHIMA, Ibaraki-shi (JP); Ikkou HANAKI, Ibaraki-shi (JP); Shou UCHIDA, Ibaraki-shi (JP); Kouhei TAKEDA, Ibaraki-shi (JP); Keiji HAYASHI, Ibaraki-shi (JP); Kooki OOYAMA, Ibaraki-shi (JP); Naoto HAYASHI, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION, Osaka (JP)

(21) Appl. No.: 12/829,640

(22) Filed: Jul. 2, 2010

(30) Foreign Application Priority Data
Jul. 3, 2009 (JP) 2009-158543
Jul. 3, 2009 (JP) 2009-158544
Mar. 24, 2010 (JP) 2010-067738
Mar. 24, 2010 (JP) 2010-067739

(51) Int. Cl. B32B 27/00; C09J 7/02; B32B 27/32

(52) U.S. Cl. 428/336; 428/411.1; 428/141; 428/521; 428/354

(57) ABSTRACT

Provided is a laminated film and a pressure-sensitive adhesive tape in each of which a difference between an image clarity in a lengthwise direction and an image clarity in a widthwise direction is small and hence the distortion of transmitted light is small, and desired mechanical properties are substantially free of reduction. The laminated film of the present invention is a laminated film including a base material layer, and a surface layer, in which the base material layer contains a thermoplastic resin, and the absolute value of a difference between an image clarity in the lengthwise direction of the laminated film and an image clarity in the widthwise direction of the laminated film is 10% or less.

### TECHNICAL FIELD

The present invention relates to a laminated film and a pressure-sensitive adhesive tape, and more specifically, to a laminated film and a pressure-sensitive adhesive tape in each of which a difference between an image clarity in a lengthwise direction and an image clarity in a widthwise direction is small.

### BACKGROUND ART

In general, the haze value and surface roughness of each of films and pressure-sensitive adhesive tapes are adjusted in accordance with a purpose of the film or tape (such as the adjustment of an external appearance). A T-die extrusion touch roll molding method, i.e., a method involving bringing a molten resin extruded from a T-die into contact with a metal roll having an uneven pattern to transfer the uneven pattern onto the surface of the resin (film surface) has been known as a method of adjusting the haze value and the surface roughness (for example, Japanese Patent Application Laid-open No. 2003-181962 and Japanese Patent Application Laid-open No. 2004-149639).

However, when high-speed forming is to be performed, the T-die extrusion touch roll molding method involves such a problem related to imperfect processing that the molten resin winds around the metal roll owing to insufficient cooling of the resin or such a problem that the uneven pattern of the metal roll is not sufficiently transferred onto the resin.

Further, in the T-die extrusion touch roll molding method, a tough roll rubber surface is also generally subjected to uneven processing in order that the releasability of the film may be improved. Since the unevenness affects the haze value of the film, the following problem arises. That is, a film having a desired haze value (in particular, a middle to low haze value) is hardly obtained.

A film forming method except the T-die extrusion touch roll molding method is, for example, a T-die air-knife forming method or an inflation air-cooling forming method. However, those methods each involve forming unevenness on a film surface only by flow deformation during a time period commencing on the time of the melting of a resin and ending on the time of solidification by cooling. Accordingly, it is difficult to form the unevenness on the film surface precisely.

Attempts have been made to adjust a haze value even at the time of air-cooling forming by intentionally forming a sea-island phase-separated structure with two or more resins that are hardly compatible with each other as resins of which a film is formed. However, in order that the haze value and surface roughness of the entire film may be adjusted by controlling its sea-island structure, the thickness of the film must be secured in accordance with the adjustment. Accordingly, the thinning of the film is hardly achieved. In addition, the composition of the materials to be used in the film formation must be adjusted on an as-needed basis depending on a desired haze value and desired surface roughness. As a result, the mechanical properties of the entire film largely fluctuate in association with the adjustment of the haze value and the surface roughness. Accordingly, it is difficult to independently adjust the mechanical properties of the entire film, and the haze value and surface roughness of the film.

Films and pressure-sensitive adhesive tapes are each generally formed by elongating and deforming a film-forming material abruptly and largely. The films each formed by the elongation and deformation are each apt to show differences in physical properties between its lengthwise direction and widthwise direction. In particular, light transmission property is susceptible to the elongation and deformation, and hence the films each formed by the elongation and deformation are each apt to show a difference in image clarity between its lengthwise direction and widthwise direction. The films each having such difference in image clarity causes the distortion of transmitted light. Accordingly, for example, when any one of the films is used as a protective film, it is difficult to inspect the external appearance of an adherend through the protective film.

The above-mentioned difference in image clarity depends on, for example, the film-forming material and a condition under which any such film is formed. Accordingly, it is difficult to achieve compatibility between the reduction of the above-mentioned difference in image clarity and the expression of mechanical properties requested of the entire film.

### SUMMARY OF INVENTION

### Technical Problem

The present invention has been made to solve the above-mentioned conventional problems, and an object of the present invention is to provide a laminated film and a pressure-sensitive adhesive tape in each of which a difference between an image clarity in a lengthwise direction and an image clarity in a widthwise direction is small and hence the distortion of transmitted light is small; and desired mechanical properties are substantially free of reduction.

### Solution to Problem

A laminated film of the present invention is a laminated film including a base material layer, and a surface layer, in which the base material layer contains a thermoplastic resin, and the absolute value of a difference between an image clarity in the lengthwise direction of the laminated film and an image clarity in the widthwise direction of the laminated film is 10% or less.

In a preferred embodiment, the image clarity in the lengthwise direction of the laminated film of the present invention is 20% or less, and the image clarity in the widthwise direction of the film is 20% or less.

In a preferred embodiment, the laminated film of the present invention has a haze value of 30% to 80%.

In a preferred embodiment, the above-mentioned surface layer has an arithmetic average surface roughness Ra of 0.5 μm to 2.0 μm.

In a preferred embodiment, the surface layer has a thickness of 2 μm to 10 μm.

In a preferred embodiment, the surface layer has two or more melting temperatures Tm in differential scanning calorimetry.

In a preferred embodiment, the surface layer contains a polyethylene and an ethylene-vinyl acetate copolymer.

In a more preferred embodiment, a weight ratio between the polyethylene and the ethylene-vinyl acetate copolymer “polyethylene:ethylene-vinyl acetate copolymer” is 20:80 to 80:20.

In a more preferred embodiment, a content of a constituent unit derived from vinyl acetate in the ethylene-vinyl acetate copolymer is 10 wt % or more.

In a more preferred embodiment, the polyethylene has a melt flow rate of 8 g/10 min to 100 g/10 min.

In a more preferred embodiment, the ethylene-vinyl acetate copolymer has a melt flow rate of 0.1 g/10 min to 7 g/10 min.

In a preferred embodiment, the surface layer contains a polyethylene and a propylene-based polymer.

In a more preferred embodiment, a weight ratio between the polyethylene and the propylene-based polymer “polyethylene:propylene-based polymer” is 10:90 to 90:10.

In a more preferred embodiment, the polyethylene has a melt flow rate of 8 g/10 min to 100 g/10 min.

In a more preferred embodiment, the propylene-based polymer has a melt flow rate of 0.1 g/10 min to 7 g/10 min.

According to another aspect of the present invention, a pressure-sensitive adhesive tape is provided. The pressure-sensitive adhesive tape has a pressure-sensitive adhesive layer on one side of the laminated film.

In a preferred embodiment, the absolute value of a difference between an image clarity in the lengthwise direction of the above-mentioned pressure-sensitive adhesive tape and an image clarity in the widthwise direction of the pressure-sensitive adhesive tape is 10% or less.

In a preferred embodiment, the image clarity in the lengthwise direction of the above-mentioned pressure-sensitive adhesive tape is 20% or less, and the image clarity in the widthwise direction of the pressure-sensitive adhesive tape is 20% or less.

In a preferred embodiment, the pressure-sensitive adhesive tape has a haze value of 30% to 80%.

In a preferred embodiment, the surface layer has a long-chain alkyl-based releasing agent.

### Advantageous Effects of Invention

According to the present invention, the laminated film and the pressure-sensitive adhesive tape in each of which the difference between the image clarity in the lengthwise direction and the image clarity in the widthwise direction is small and hence the distortion of transmitted light is small can be obtained by virtue of the presence of the surface layer containing a specific resin. In addition, the surface layer in each of the laminated film and pressure-sensitive adhesive tape of the present invention is so thin that the difference between the image clarity in the lengthwise direction and the image clarity in the widthwise direction can be reduced with substantially no reductions in mechanical properties requested of the entire laminated film or pressure-sensitive adhesive tape. Further, each of the laminated film and pressure-sensitive adhesive tape of the present invention is available at a low cost because of its excellent productivity.

### BRIEF DESCRIPTION OF DRAWINGS

FIG. 1 is a schematic sectional view of a laminated film according to a preferred embodiment of the present invention.

FIG. 2 is a schematic sectional view of a pressure-sensitive adhesive tape according to a preferred embodiment of the present invention.

### DESCRIPTION OF EMBODIMENTS

### A. Laminated Film

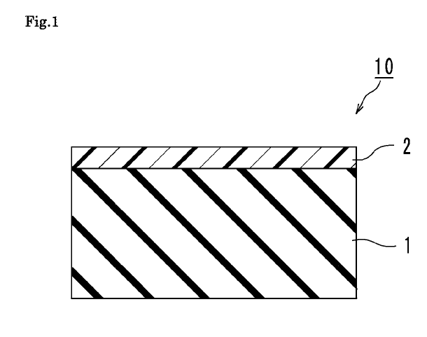

A laminated film of the present invention has a base material layer and a surface layer. FIG. 1 is a schematic sectional view of the laminated film according to a preferred embodiment of the present invention. A laminated film 10 includes a base material layer 1 and a surface layer 2 placed on one side, or each of both sides, of the base material layer 1 (one side in the illustrated example). The laminated film of the present invention may further have any appropriate other layer (not illustrated) as required. The other layer may be provided at any position except the side of the surface layer 2 where the base material layer 1 is not placed.

The thickness of the laminated film of the present invention can be set to any appropriate thickness depending on applications. The thickness is preferably 10 μm to 200 μm, more preferably 10 μm to 180 μm, or still more preferably 12 μm to 170 μm.

In the laminated film of the present invention, the absolute value of a difference between an image clarity in the lengthwise direction of the laminated film and an image clarity in the widthwise direction of the laminated film is 10% or less, preferably 8% or less, or more preferably 5% or less. In the laminated film of the present invention, the distortion of light transmitting through the laminated film can be reduced as long as the absolute value of the difference between the image clarity in the lengthwise direction of the laminated film and the image clarity in the widthwise direction of the laminated film falls within such range. As a result, for example, when the laminated film of the present invention is used as a protective film and the external appearance of an adherend to which the laminated film is attached is inspected through the laminated film, a defect of the adherend can be detected with ease and efficiency. In addition, when the laminated film of the present invention is used in an application where design is requested, excellent design can be expressed. It should be noted that the term “lengthwise direction” as used herein refers to the direction in which the film is conveyed at the time of film forming, and the term “widthwise direction” as used herein refers to a direction perpendicular to the above-mentioned lengthwise direction. In addition, the term “image clarity in the lengthwise direction” as used herein refers to an image clarity when measurement is performed so that the line direction of the transmission portion of an optical comb used upon measurement of an image clarity may be parallel to the lengthwise direction of the film, and the term “image clarity in the widthwise direction” as used herein refers to an image clarity when measurement is performed so that the line direction of the transmission portion of the optical comb described above may be perpendicular to the lengthwise direction of the film. The image clarity can be measured by a method in conformity with JIS K7105.

The image clarity in the lengthwise direction of the laminated film of the present invention is preferably 20% or less, more preferably 15% or less, still more preferably 10% or less, particularly preferably 8% or less, or most preferably 4% to 8%. The image clarity in the widthwise direction of the laminated film of the present invention is preferably 20% or less, more preferably 15% or less, still more preferably 10% or less, particularly preferably 8% or less, or most preferably 4% to 8%. Suppose that, in the laminated film of the present invention, the image clarity in the lengthwise direction of the laminated film and the image clarity in the widthwise direction of the laminated film are each larger than 20%. For example, when the laminated film of the present invention is used as a protective film and the external appearance of an adherend to which the laminated film is attached is inspected through the laminated film, even a defect that does not result from the adherend (such as a defect in the laminated film or foreign matter mixed upon attachment of the laminated film) is apt to be detected. As a result, the efficiency with which a defect of the adherend to be intrinsically detected is inspected may reduce.

The laminated film of the present invention has a haze value of preferably 30% to 80%, or more preferably 35% to 75%. As long as the haze value of the laminated film falls within such range, the laminated film has an external appearance suitable for a protective film application and an external appearance-adjusting application. When the haze value of the laminated film is smaller than 30%, the above-mentioned desired image clarity may not be obtained. The haze value can be measured by a method in conformity with JIS K7136 (2000).

### A-1. Base Material Layer

Any appropriate thickness can be adopted as the thickness of the above-mentioned base material layer, depending on applications. The thickness of the above-mentioned base material layer is preferably 10 μm to 150 μm, or more preferably 20 μm to 100 μm.

The above-mentioned base material layer has a haze value of preferably 1% to 80%, or more preferably 10% to 60%. As long as the haze value of the base material layer falls within such range, a laminated film having an external appearance suitable for a protective film application and an external appearance-adjusting application can be obtained. When the haze value of the base material layer is smaller than 30%, a laminated filmhaving the above-mentioned desired image clarity may not be obtained.

The above-mentioned base material layer contains a thermoplastic resin. Any appropriate resin can be adopted as the above-mentioned thermoplastic resin as long as film forming by melt extrusion can be performed. Examples of the above-mentioned thermoplastic resin include: polyolefin resins such as a propylene-based polymer, a polyethylene, and an olefin-based thermoplastic elastomer (TPO) and modified products thereof; α-olefin-vinyl compound (such as vinyl acetate and (meth)acrylic acid ester) copolymers; polyamides; polyesters; polycarbonates; polyurethanes; and polyvinyl chlorides. Examples of the propylene-based polymer include a homopolypropylene, a block polypropylene, and a random polypropylene.

When a homopolypropylene is used as the above-mentioned thermoplastic resin, the structure of the homopolypropylene may be any one of an isotactic structure, an atactic structure, and a syndiotactic structure.

When a polyethylene is used as the above-mentioned thermoplastic resin, the polyethylene may be anyone of a low-density polyethylene, a medium-density polyethylene, and a high-density polyethylene.

In the above-mentioned base material layer, one kind of the above-mentioned thermoplastic resins may be used alone, or two or more kinds of them may be used in combination. When two or more kinds of the resins are used in combination, the resins may be blended, or may be copolymerized.

A commercially available product may be used as the above-mentioned thermoplastic resin. A specific example of the commercially available thermoplastic resin is a product available under the trade name “PF380A” (block polypropylene) from SunAllomer Ltd.

The above-mentioned base material layer can contain any appropriate additive as required. Examples of the additive that can be incorporated into the base material layer include a UV absorbing agent, a thermal stabilizer, a filler, and a lubricant. The kinds, number, and amount of additives to be incorporated into the above-mentioned base material layer can be appropriately set depending on purposes.

Examples of the above-mentioned UV absorbing agent include a benzotriazole-based compound, a benzophenone-based compound, and a benzoate-based compound. Any appropriate content can be adopted as the content of the above-mentioned UV absorbing agent as long as the agent does not bleed out at the time of the forming of the laminated film. The content is representatively 0.01 part by weight to 5 parts by weight with respect to 100 parts by weight of the thermoplastic resin in the base material layer.

Examples of the above-mentioned thermal stabilizer include a hindered amine-based compound, a phosphorus-based compound, and a cyanoacrylate-based compound. Any appropriate content can be adopted as the content of the above-mentioned thermal stabilizer as long as the stabilizer does not bleed out at the time of the forming of the laminated film. The content is representatively 0.01 part by weight to 5 parts by weight with respect to 100 parts by weight of the thermoplastic resin in the base material layer.

Examples of the above-mentioned filler include inorganic fillers such as talc, titanium oxide, calcium carbonate, clay, mica, barium sulfate, whisker, and magnesium hydroxide. The filler preferably has an average particle diameter of 0.1 μm to 10 μm. The content of the filler is preferably 1 part by weight to 200 parts by weight with respect to 100 parts by weight of the thermoplastic resin in the base material layer.

### A-2. Surface Layer

The above-mentioned surface layer has a thickness of preferably 2 μm to 10 μm, more preferably 2 μm to 8 μm, or particularly preferably 2 μm to 5 μm. When the thickness of the surface layer is smaller than 2 μm, it may become difficult to obtain desired surface roughness and a laminated film having a high haze value. When the thickness of the surface layer is larger than 10 μm, the mechanical properties of the surface layer affect the mechanical properties of the entire laminated film or pressure-sensitive adhesive tape having the surface layer. As a result, the mechanical properties of the entire laminated film or pressure-sensitive adhesive tape may reduce, or the handling of the laminated film or pressure-sensitive adhesive tape may deteriorate.

The above-mentioned surface layer has a haze value of preferably 30% to 80%, or more preferably 35% to 75%. As long as the haze value of the surface layer falls within such range, a laminated film having an external appearance suitable for a protective film application and an external appearance-adjusting application can be obtained. When the haze value of the surface layer is smaller than 30%, a laminated film having the above-mentioned desired image clarity may not be obtained.

The above-mentioned surface layer has an arithmetic average surface roughness Ra of preferably 0.5 μm to 2.0 μm, more preferably 0.8 μm to 1.9 μm, or still more preferably 1.0 μm to 1.9 μm. As long as the arithmetic average surface roughness Ra of the surface layer falls within such range, a laminated film having an external appearance suitable for a protective film application and an external appearance-adjusting application can be obtained.

The above-mentioned surface layer can contain any appropriate resin to such an extent that an effect of the present invention can be expressed. The following two preferred embodiments are exemplified:
(Embodiment 1) an embodiment in which the above-mentioned surface layer contains a polyethylene and an ethylene-vinyl acetate copolymer;
(Embodiment 2) an embodiment in which the above-mentioned surface layer contains a polyethylene and a propylene-based polymer; and

First, the case of (Embodiment 1) described above is described.

In (Embodiment 1) described above, the above-mentioned surface layer contains the polyethylene and the ethylene-vinyl acetate copolymer. Any appropriate weight ratio can be adopted as a weight ratio between the polyethylene and the ethylene-vinyl acetate copolymer described above depending on a desired haze value and/or desired surface roughness. The weight ratio (polyethylene:ethylene-vinyl acetate copolymer) is preferably 20:80 to 80:20, more preferably 30:70 to 80:20, or particularly preferably 30:70 to 70:30.

The above-mentioned polyethylene and the above-mentioned ethylene-vinyl acetate copolymer preferably show different melt flow rates. When the polyethylene and the ethylene-vinyl acetate copolymer described above show different melt flow rates, the resin having the higher melt flow rate is easily elongated and the resin having the lower melt flow rate is hardly elongated upon forming by the elongation of each material of which the surface layer is formed in a thermally molten state. Accordingly, a surface layer having a sea-island structure in which the resin having the higher melt flow rate forms a sea portion and the resin having the lower melt flow rate forms an island portion can be obtained. When the surface layer has the above-mentioned island portion to which an elongation stress is hardly applied and which elongates and deforms to a small extent, a laminated film having a small difference between the image clarity in its lengthwise direction and the image clarity in its widthwise direction can be obtained.

The above-mentioned polyethylene has a melt flow rate of preferably 8 g/10 min to 100 g/10 min, more preferably 9 g/10 min to 80 g/10 min, particularly preferably 9 g/10 min to 50 g/10 min, or most preferably 10 g/10 min to 50 g/10 min. As long as the melt flow rate of the polyethylene falls within such range, a laminated film having a haze value and surface roughness suitable for a protective film application and an external appearance-adjusting application can be obtained. When the melt flow rate of the polyethylene is smaller than 8 g/10 min, a difference in melt flow rate between the polyethylene and the above-mentioned ethylene-vinyl acetate copolymer reduces, and hence the difference between the image clarity in the lengthwise direction of the laminated film and the image clarity in the widthwise direction of the film may become excessively large. The melt flow rate can be measured by a method in conformity with JIS K7210.

The above-mentioned ethylene-vinyl acetate copolymer has a melt flow rate of preferably 0.1 g/10 min to 7 g/10 min, more preferably 0.2 g/10 min to 5 g/10 min, particularly preferably 0.2 g/10 min to 3 g/10 min, or most preferably 0.4 g/10 min to 2.8 g/10 min. As long as the melt flow rate of the ethylene-vinyl acetate copolymer falls within such range, a laminated film having a haze value and surface roughness suitable for a protective film application and an external appearance-adjusting application can be obtained. When the melt flow rate of the ethylene-vinyl acetate copolymer is larger than 7 g/10 min, the difference in melt flow rate between the above-mentioned polyethylene and the ethylene-vinyl acetate copolymer reduces, and hence the difference between the image clarity in the lengthwise direction of the laminated film and the image clarity in the widthwise direction of the film may become excessively large.

As long as the melt flow rates of the polyethylene and the ethylene-vinyl acetate copolymer described above fall within such ranges as described above, a surface layer having a sea-island structure in which the polyethylene forms a sea portion and the ethylene-vinyl acetate copolymer forms an island portion can be obtained.

When a difference in viscosity between a low-viscosity resin (showing the higher melt flow rate) and a high-viscosity resin (showing the lower melt flow rate) is small, a clear difference in flow deformation is hardly obtained, and hence no sea-island structure can be obtained. As a result, a laminated film having a low haze and a smooth surface roughness can be obtained. On the other hand, when the difference in viscosity between the low-viscosity resin (showing the higher melt flow rate) and the high-viscosity resin (showing the lower melt flow rate) is large, a clear difference in flow deformation can be obtained, and hence a sea-island structure becomes clear. As a result, a laminated film having a high haze and a rough surface roughness can be obtained. A targeted haze or targeted surface roughness can be controlled depending on the difference in viscosity between the resins to be used. In addition, the melting point of the high-viscosity resin serving as an island structure is preferably higher than the melting point of the low-viscosity resin serving as a sea structure in order that a high haze and a rough surface roughness may be obtained. This is because of the following reason. At the time of an elongation flow, the island structure previously solidifies by cooling and the high-viscosity resin as a sea-forming resin does not solidify by cooling at the time of the solidification, and hence a clear sea-island structure is formed.

The above-mentioned surface layer preferably has two or more melting temperatures Tm in differential scanning calorimetry (DSC). Such surface layer can be obtained by using a polyethylene and an ethylene-vinyl acetate copolymer having different melting points. The haze value and surface roughness of the laminated film can be adjusted by using the polyethylene and the ethylene-vinyl acetate copolymer having different melting points in the surface layer by virtue of the difference in melting point. Accordingly, the external appearance of the laminated film can be controlled. To be additionally specific, when the difference in melting point is large, a clear sea-island structure can be obtained in the above-mentioned surface layer because, upon solidification by cooling after thermal melting at the time of the forming of the film, the polyethylene having the higher melting point previously solidifies before the ethylene-vinyl acetate copolymer having the lower melting point solidifies. As a result, a laminated film having a large haze value and large surface roughness can be obtained. On the other hand, when the difference in melting point is small, a surface layer having a clear sea-island structure is hardly obtained, and hence a laminated film having a small haze value and small surface roughness can be obtained. It should be noted that the above-mentioned melting points Tm can be measured by a method in conformity with JIS K7121. The phrase “has two or more melting points Tm” as used herein refers to a state in which two or more melting endothermic peaks appear in a DSC curve.

The polyethylene has a melting point of preferably 100° C. to 125° C., more preferably 105° C. to 125° C., still more preferably 110 to 125° C., or particularly preferably 115° C. to 120° C.

The ethylene-vinyl acetate copolymer has a melting point of preferably 50° C. to 120° C., more preferably 60° C. to 120° C., still more preferably 70 to 120° C., particularly preferably 80 to 115° C., or most preferably 100 to 115° C.

A difference between the melting point of the above-mentioned polyethylene and the melting point of the above-mentioned ethylene-vinyl acetate copolymer is preferably 5° C. to 65° C., more preferably 10° C. to 60° C., or particularly preferably 15° C. to 50° C. As long as the difference between the melting point of the polyethylene and the melting point of the ethylene-vinyl acetate copolymer falls within such range, a laminated film having a haze value and surface roughness suitable for a protective film application and an external appearance-adjusting application can be obtained.

The haze value and surface roughness of the laminated film of the present invention can be adjusted by compatibility between the polyethylene and the ethylene-vinyl acetate copolymer described above in the above-mentioned surface layer as well. When the compatibility between the polyethylene and the ethylene-vinyl acetate copolymer is low, a clear sea-island structure can be obtained in the above-mentioned surface layer, and hence a laminated film having a large haze value and large surface roughness can be obtained. On the other hand, when the compatibility is high, a clear sea-island structure is hardly obtained, and hence a laminated film having a small haze value and small surface roughness can be obtained. The compatibility can be adjusted by, for example, the content of a constituent unit derived from vinyl acetate in the ethylene-vinyl acetate copolymer.

The content of the constituent unit derived from vinyl acetate in the above-mentioned ethylene-vinyl acetate copolymer is preferably 10 wt % or more, more preferably 15 wt % or more, particularly preferably 20 wt % or more, or most preferably 20 wt % to 30 wt %. As long as the content of the constituent unit derived from vinyl acetate falls within such range, the above-mentioned ethylene-vinyl acetate copolymer shows appropriate compatibility with the above-mentioned polyethylene, and hence a laminated film having a haze value and surface roughness suitable for a protective film application and an external appearance-adjusting application can be obtained.

Commercially available products may be used as the polyethylene and the ethylene-vinyl acetate copolymer described above. Specific examples of the commercially available polyethylene include a product available under the trade name “Petrocene 209” from TOSOH CORPORATION, and products available under the trade names “NOVATEC LD LJ803”, “NOVATEC LD LC701”, and “NOVATEC LD LC720” from Japan Polyethylene Corporation. A specific example of the commercially available ethylene-vinyl acetate copolymer is a product available under the trade name “EVAFLEX EV270” from DUPONT-MITSUI POLYCHEMICALS CO., LTD.

The above-mentioned surface layer can contain any appropriate additive as required. For example, any one of the additives described in the section A-1 can be used as the additive that can be incorporated into the surface layer.

Next, the case of (Embodiment 2) described above is described.

In (Embodiment 2) described above, the above-mentioned surface layer contains the polyethylene and the propylene-based polymer. Any appropriate weight ratio can be adopted as a weight ratio between the polyethylene and the propylene-based polymer described above depending on a desired haze value and/or desired surface roughness. The weight ratio (polyethylene:propylene-based polymer) is preferably 10:90 to 90:10, more preferably 20:80 to 80:20, or particularly preferably 30:70 to 70:30.

The above-mentioned polyethylene and the above-mentioned propylene-based polymer preferably show different melt flow rates. When the polyethylene and the propylene-based polymer described above show different melt flow rates, the resin having the higher melt flow rate is easily elongated and the resin having the lower melt flow rate is hardly elongated upon forming by the elongation of each material of which the surface layer is formed in a thermally molten state. Accordingly, a surface layer having a sea-island structure in which the resin having the higher melt flow rate forms a sea portion and the resin having the lower melt flow rate forms an island portion can be obtained. When the surface layer has the above-mentioned island portion to which an elongation stress is hardly applied and which elongates and deforms to a small extent, a laminated film having a small difference between the image clarity in its lengthwise direction and the image clarity in its widthwise direction can be obtained.

The above-mentioned polyethylene has a melt flow rate of preferably 8 g/10 min to 100 g/10 min, more preferably 9 g/10 min to 80 g/10 min, particularly preferably 9 g/10 min to 50 g/10 min, or most preferably 15 g/10 min to 50 g/10 min. As long as the melt flow rate of the polyethylene falls within such range, a laminated film having a haze value and surface roughness suitable for a protective film application and an external appearance-adjusting application can be obtained. When the melt flow rate of the polyethylene is smaller than 8 g/10 min, a difference in melt flow rate between the polyethylene and the above-mentioned propylene-based polymer reduces, and hence the difference between the image clarity in the lengthwise direction of the laminated film and the image clarity in the widthwise direction of the film may become excessively large. The melt flow rate can be measured by a method in conformity with JIS K7210.

The above-mentioned propylene-based polymer has a melt flow rate of preferably 0.1 g/10 min to 7 g/10 min, more preferably 0.2 g/10 min to 5 g/10 min, particularly preferably 0.2 g/10 min to 3 g/10 min, or most preferably 0.4 g/10 min to 2.8 g/10 min. As long as the melt flow rate of the propylene-based polymer falls within such range, a laminated film having a haze value and surface roughness suitable for a protective film application and an external appearance-adjusting application can be obtained. When the melt flow rate of the propylene-based polymer is larger than 7 g/10 min, the difference in melt flow rate between the above-mentioned polyethylene and the propylene-based polymer reduces, and hence the difference between the image clarity in the lengthwise direction of the laminated film and the image clarity in the widthwise direction of the film may become excessively large.

As long as the melt flow rates of the polyethylene and the propylene-based polymer described above fall within such ranges as described above, a surface layer having a sea-island structure in which the polyethylene forms a sea portion and the propylene-based polymer forms an island portion can be obtained.

When a difference in viscosity between a low-viscosity resin (showing the higher melt flow rate) and a high-viscosity resin (showing the lower melt flow rate) is small, a clear difference in flow deformation is hardly obtained, and hence no sea-island structure can be obtained. As a result, a laminated film having a low haze and a smooth surface roughness can be obtained. On the other hand, when the difference in viscosity between the low-viscosity resin (showing the higher melt flow rate) and the high-viscosity resin (showing the lower melt flow rate) is large, a clear difference in flow deformation can be obtained, and hence a sea-island structure becomes clear. As a result, a laminated film having a high haze and a rough surface roughness can be obtained. A targeted haze or targeted surface roughness can be controlled depending on the difference in viscosity between the resins to be used. In addition, the melting point of the high-viscosity resin serving as an island structure is preferably higher than the melting point of the low-viscosity resin serving as a sea structure in order that a high haze and a rough surface roughness may be obtained. This is because of the following reason. At the time of an elongation flow, the island structure previously solidifies by cooling and the high-viscosity resin as a sea-forming resin does not solidify by cooling at the time of the solidification, and hence a clear sea-island structure is formed. Accordingly, a propylene-based polymer or the like is preferably used as the high-viscosity resin serving as the island structure, and any one of the low-melting resins such as various polyethylenes is preferably used as the low-viscosity resin serving as the sea structure in order that a laminated film having a high haze and a rough surface roughness may be formed.

The above-mentioned surface layer preferably has two or more melting temperatures Tm in differential scanning calorimetry (DSC). Such surface layer can be obtained by using a polyethylene and a propylene-based polymer having different melting points. The haze value and surface roughness of the laminated film can be adjusted by using the polyethylene and the propylene-based polymer having different melting points in the surface layer by virtue of the difference in melting point. Accordingly, the external appearance of the laminated film can be controlled. To be additionally specific, when the difference in melting point is large, a clear sea-island structure can be obtained in the above-mentioned surface layer because, upon solidification by cooling after thermal melting at the time of the forming of the film, the propylene-based polymer having the higher melting point previously solidifies before the polyethylene having the lower melting point solidifies. As a result, a laminated film having a large haze value and large surface roughness can be obtained. On the other hand, when the difference in melting point is small, a surface layer having a clear sea-island structure is hardly obtained, and hence a laminated film having a small haze value and small surface roughness can be obtained. It should be noted that the above-mentioned melting points Tm can be measured by a method in conformity with JIS K7121. The phrase “has two or more melting points Tm” as used herein refers to a state in which two or more melting endothermic peaks appear in a DSC curve.

The polyethylene has a melting point of preferably 100° C. to 125° C., more preferably 105° C. to 125° C., still more preferably 110 to 125° C., or particularly preferably 115° C. to 120° C.

The propylene-based polymer has a melting point of preferably 125° C. to 200° C., more preferably 125° C. to 180° C., still more preferably 125 to 170° C., particularly preferably 125 to 165° C., or most preferably 130 to 165° C.

A difference between the melting point of the above-mentioned polyethylene and the melting point of the above-mentioned propylene-based polymer is preferably 5° C. to 65° C., more preferably 10° C. to 60° C., or particularly preferably 15° C. to 50° C. As long as the difference between the melting point of the polyethylene and the melting point of the propylene-based polymer falls within such range, a laminated film having a haze value and surface roughness suitable for a protective film application and an external appearance-adjusting application can be obtained.

The haze value and surface roughness of the laminated film of the present invention can be adjusted by compatibility between the polyethylene and the propylene-based polymer described above in the above-mentioned surface layer as well. When the compatibility between the polyethylene and the propylene-based polymer is low, a clear sea-island structure can be obtained in the above-mentioned surface layer, and hence a laminated film having a large haze value and large surface roughness can be obtained. On the other hand, when the compatibility is high, a clear sea-island structure is hardly obtained, and hence a laminated film having a small haze value and small surface roughness can be obtained.

Commercially available products may be used as the polyethylene and the propylene-based polymer described above.

Specific examples of the commercially available polyethylene include a product available under the trade name “Petrocene 209” from TOSOH CORPORATION, and products available under the trade names “NOVATEC LD LJ803”, “NOVATEC LD LC701”, and “NOVATEC LD LC720” from Japan Polyethylene Corporation. A specific example of the commercially available propylene-based polymer is a product available under the trade name “NOVATEC PP EG8” from Japan Polypropylene Corporation.

The above-mentioned surface layer can contain any appropriate additive as required. For example, any one of the additives described in the section A-1 can be used as the additive that can be incorporated into the surface layer.

### A-3. Other Layer

The laminated film of the present invention may further have any appropriate other layer (not illustrated) as required. The other layer may be provided at any position except the side of the surface layer where the base material layer is not placed.

The above-mentioned other layer has a thickness of preferably 2 μm to 12 μm, or more preferably 5 μm to 10 μm.

Any appropriate value can be adopted as the haze value of the above-mentioned other layer depending on the haze value of the laminated film of the present invention.

The above-mentioned other layer is, for example, a smooth layer. For example, when the above-mentioned laminated film has the surface layer on one side of the base material layer, the smooth layer can be used by being placed on the side of the base material layer where the surface layer is not placed.

Any appropriate material can be adopted as a material of which the above-mentioned smooth layer is constituted. A polyolefin resin such as a polyethylene, a polypropylene, or a TPO can be adopted as the material of which the smooth layer is constituted. Specific examples of the polyolefin resin include various thermoplastic resins such as: various polyethylenes having low to high densities; and various polypropylenes including isotactic, atactic, and syndiotactic polypropylenes. In addition, a modified product of an α-olefin, a copolymer of an α-olefin and any one of various vinyl compounds such as vinyl acetate and a methacrylate, or such a thermoplastic resin as to be mainly formed of, for example, a polyamide, polyester, polycarbonate, polyurethane, or polyvinyl chloride as well as the polyolefin resin may be adopted. One kind of those materials may be used alone, or two or more kinds of them may be used in combination.

### A-4. Method of Forming Laminated Film

The above-mentioned laminated film can be obtained by any appropriate forming method. A representative example of the method involves subjecting the above-mentioned base material layer and the above-mentioned surface layer, and as required, the other layer to co-extrusion. The co-extrusion method can be performed with an extruder and a co-extrusion die for the respective materials of which the respective layers are formed in conformity with, for example, an inflation method or a T-die method. Any other production method is, for example, a method involving attaching the base material layer and the surface layer, and as required, the other layer each formed by a calender forming method with any appropriate adhesive.

### B. Pressure-Sensitive Adhesive Tape

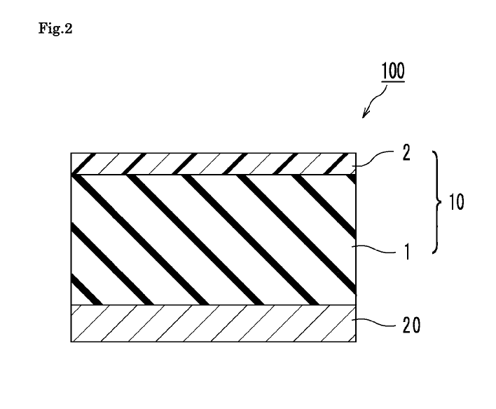

A pressure-sensitive adhesive tape of the present invention has the laminated film of the present invention and a pressure-sensitive adhesive layer placed on one side of the laminated film. FIG. 2 is a schematic sectional view of a pressure-sensitive adhesive tape according to a preferred embodiment of the present invention. A pressure-sensitive adhesive tape 100 includes the laminated film 10 and a pressure-sensitive adhesive layer 20 placed on the side of the laminated film 10 where the surface layer 2 is not placed. The laminated film 10 of which the pressure-sensitive adhesive tape of the present invention is constituted is the laminated film of the present invention described above, and includes the base material layer 1 described in the section A-1 and the surface layer 2 described in the section A-2.

The surface layer used in the pressure-sensitive adhesive tape of the present invention preferably further contains a long-chain alkyl-based releasing agent. When the surface layer contains the long-chain alkyl-based releasing agent, the attachment of the surface layer and the pressure-sensitive adhesive layer in a state in which portions of the pressure-sensitive adhesive tape overlap each other such as storage in a roll shape can be prevented. In addition, there is no need to cover the surface layer with a separator layer, and hence a pressure-sensitive adhesive tape having a desired haze value and desired surface roughness can be easily obtained.

The above-mentioned long-chain alkyl-based releasing agent contains a long-chain alkyl-based polymer. The long-chain alkyl-based polymer can be obtained by causing a polymer having a reactive group and a compound having an alkyl group capable of reacting with the reactive group to react with each other in any appropriate heated solvent. A catalyst may be used as required at the time of the reaction. Examples of the catalyst include a tin compound and a tertiary amine.

Examples of the above-mentioned reactive group include a hydroxyl group, an amino group, a carboxyl group, and a maleic anhydride group. Examples of a polymer having the reactive group include an ethylene-vinyl alcohol copolymer, polyvinyl alcohol, polyethylenimine, polyethylenamine, a styrene-maleic anhydride copolymer. Of those, an ethylene-vinyl alcohol copolymer is preferred. It should be noted that the term “ethylene-vinyl alcohol copolymer” also includes a partially saponified product of ethylene-vinyl acetate copolymer. The term “polyvinyl alcohol” also includes a partially saponified product of polyvinyl acetate.

The number of carbon atoms of the above-mentioned alkyl group is preferably 8 to 30, or more preferably 12 to 22. When the number of carbon atoms of the above-mentioned alkyl group falls within such range, a surface layer having excellent releasability can be obtained. Specific examples of such alkyl group include a lauryl group, a stearyl group, and a behenyl group. Examples of a compound having such alkyl group (that is, compound having an alkyl group capable of reacting with the reactive group) include: isocyanates such as octyl isocyanate, decyl isocyanate, lauryl isocyanate, and stearylisocyanate; acid chlorides; amines; and alcohols. Of those, isocyanates are preferred.

The above-mentioned long-chain alkyl-based polymer has a weight-average molecular weight of preferably 10,000 to 1,000,000, or more preferably 20,000 to 1,000,000. When the weight-average molecular weight of the long-chain alkyl-based polymer falls within such range, a surface layer having excellent releasability can be obtained.

The above-mentioned long-chain alkyl-based releasing agent is kneaded into the surface layer upon co-extrusion of the laminated film or the pressure-sensitive adhesive tape. The content of the long-chain alkyl-based releasing agent in the above-mentioned surface layer is preferably 1 wt % to 50 wt %, more preferably 2 wt % to 30 wt %, or particularly preferably 5 wt % to 20 wt %. When the content is smaller than 1 wt %, an effect of adding the long-chain alkyl-based releasing agent may not be obtained. When the content is larger than 50 wt %, a bled product may be generated.

The thickness of the pressure-sensitive adhesive tape of the present invention can be set to any appropriate thickness depending on applications. The thickness is representatively 15 μm to 450 μm.

An image clarity in the lengthwise direction of the pressure-sensitive adhesive tape of the present invention is preferably 20% or less, more preferably 15% or less, still more preferably 10% or less, particularly preferably 8% or less, or most preferably 4% to 8%. An image clarity in the widthwise direction of the pressure-sensitive adhesive tape of the present invention is preferably 20% or less, more preferably 10% or less, particularly preferably 8% or less, or most preferably 4% to 8%. Suppose that, in the pressure-sensitive adhesive tape of the present invention, the image clarity in the lengthwise direction of the pressure-sensitive adhesive tape and the image clarity in the widthwise direction of the pressure-sensitive adhesive tape are each larger than 20%. For example, when the pressure-sensitive adhesive tape of the present invention is used as a protective film and the external appearance of an adherend to which the pressure-sensitive adhesive tape is attached is inspected through the pressure-sensitive adhesive tape, even a defect that does not result from the adherend (such as a defect in the pressure-sensitive adhesive tape or foreign matter mixed upon attachment of the pressure-sensitive adhesive tape) is apt to be detected. As a result, the efficiency with which a defect of the adherend to be intrinsically detected is inspected may reduce. A pressure-sensitive adhesive tape showing such image clarity can be obtained on condition that the pressure-sensitive adhesive tape includes the surface layer of the present invention.

In the pressure-sensitive adhesive tape of the present invention, the absolute value of a difference between the image clarity in the lengthwise direction of the pressure-sensitive adhesive tape and the image clarity in the widthwise direction of the pressure-sensitive adhesive tape is preferably 10% or less, more preferably 8% or less, or still more preferably 5% or less. In the pressure-sensitive adhesive tape of the present invention, the distortion of light transmitting through the pressure-sensitive adhesive tape can be reduced as long as the absolute value of the difference between the image clarity in the lengthwise direction of the pressure-sensitive adhesive tape and the image clarity in the widthwise direction of the pressure-sensitive adhesive tape falls within such range. As a result, for example, when the pressure-sensitive adhesive tape of the present invention is used as a protective film and the external appearance of an adherend to which the pressure-sensitive adhesive tape is attached is inspected through the pressure-sensitive adhesive tape, a defect of the adherend can be detected with ease and efficiency. In addition, when the pressure-sensitive adhesive tape of the present invention is used in an application where design is requested, excellent design can be expressed. A pressure-sensitive adhesive tape showing such difference in image clarity can be obtained on condition that the pressure-sensitive adhesive tape includes the surface layer of the present invention.

The pressure-sensitive adhesive tape of the present invention has a haze value of preferably 30% to 80%, or more preferably 35% to 75%. As long as the haze value of the pressure-sensitive adhesive tape falls within such range, the pressure-sensitive adhesive tape has an external appearance suitable for a protective film application and an external appearance-adjusting application. When the haze value of the pressure-sensitive adhesive tape is smaller than 30%, the above-mentioned desired image clarity may not be obtained. A pressure-sensitive adhesive tape showing such haze value can be obtained on condition that the pressure-sensitive adhesive tape includes the surface layer of the present invention.

### B-1. Pressure-Sensitive Adhesive Layer

The above-mentioned pressure-sensitive adhesive layer has a thickness of preferably 1 μm to 300 μm, more preferably 4 μm to 100 μm, or particularly preferably 5 μm to 50 μm.

The above-mentioned pressure-sensitive adhesive layer has a haze value of preferably 1% to 80%, or more preferably 10% to 60%. As long as the haze value of the pressure-sensitive adhesive layer falls within such range, a pressure-sensitive adhesive tape having an external appearance suitable for a protective film application and an external appearance-adjusting application can be obtained. When the haze value of the pressure-sensitive adhesive layer is smaller than 1%, a pressure-sensitive adhesive tape having the above-mentioned desired image clarity may not be obtained.

Any appropriate pressure-sensitive adhesive can be adopted as a pressure-sensitive adhesive of which the above-mentioned pressure-sensitive adhesive layer is constituted. Examples of the above-mentioned pressure-sensitive adhesive include a rubber-based pressure-sensitive adhesive, an acrylic pressure-sensitive adhesive, and a silicone-based pressure-sensitive adhesive.

A thermoplastic pressure-sensitive adhesive can also be used as the above-mentioned pressure-sensitive adhesive. A material of which the thermoplastic pressure-sensitive adhesive is constituted is, for example, any appropriate styrene-based block copolymer or acrylic thermoplastic resin as a pressure-sensitive adhesive material.

Specific examples of the above-mentioned styrene-based block copolymer include: styrene-based AB-type diblock copolymers such as a styrene-ethylene-butylene copolymer (SEB); styrene-based ABA-type triblock copolymers such as a styrene-butadiene-styrene copolymer (SBS), a hydrogenated product of SBS (styrene-ethylene-butylene-styrene copolymer (SEBS)), a styrene-isoprene-styrene copolymer (SIS), a hydrogenated product of SIS (styrene-ethylene-propylene-styrene copolymer (SEPS)), a styrene-isobutylene-styrene copolymer (SIBS); styrene-based ABAB-type tetrablock copolymers such as styrene-butadiene-styrene-butadiene (SBSB); styrene-based ABABA-type pentablock copolymers such as styrene-butadiene-styrene-butadiene-styrene (SBSBS); styrene-based multi-block copolymers having six or more of A-B repeat units; and hydrogenated product each obtained by hydrogenating ethylenic double bonds of a styrene-based random copolymer such as a styrene-butadiene rubber (SBR). Examples of a commercially available product include a “G1657” (styrene-based elastomer) manufactured by Kraton Polymers. One kind of the above-mentioned polymers may be used alone, or two or more kinds of them may be used in combination.

The content of a styrene block structure in the above-mentioned styrene-based block copolymer is preferably 5 wt % to 40 wt %, more preferably 7 wt % to 30 wt %, or particularly preferably 9 wt % to 20 wt %. When the content of the styrene block structure is smaller than 5 wt %, an adhesive residue is apt to be generated owing to an insufficient cohesive strength of the pressure-sensitive adhesive layer. When the content of the styrene block structure is larger than 40 wt %, the pressure-sensitive adhesive layer becomes hard, and good adhesion for a rough surface may not be obtained.

When the above-mentioned styrene-based block copolymer has an ethylene-butylene block structure, the content of a constituent unit derived from butylene in the ethylene-butylene block structure is preferably 50 wt % or more, more preferably 60 wt % or more, particularly preferably 70 wt % or more, or most preferably 70 wt % to 90 wt %. When the content of the constituent unit derived from butylene falls within such range, a pressure-sensitive adhesive layer excellent in wettability and adhesion, and capable of favorably bonding even to a rough surface can be obtained.

Examples of the above-mentioned acrylic thermoplastic resin include: a polymethyl methacrylate-polybutyl acrylate-polymethyl methacrylate copolymer (PMMA-PBA-PMMA copolymer); and a PMMA-functional group-containing PBA-PMMA copolymer of such a type that the polybutyl acrylate has a carboxylic acid as a functional group. A commercially available product may be used as the acrylic thermoplastic resin. Specific examples of the commercially available acrylic thermoplastic resin include a product available under the trade name “NABSTAR” from KANEKA CORPORATION and a product available under the trade name “LA Polymer” from KURARAY CO., LTD.

The above-mentioned pressure-sensitive adhesive layer can contain any other component as required. Examples of the other component include: an olefin-based resin; a silicone-based resin; a liquid acrylic copolymer; a polyethyleneimine; a fatty acid amide; a phosphate; and a general additive. The kinds, number, and amount of other components to be incorporated into the above-mentioned pressure-sensitive adhesive layer can be appropriately set depending on purposes. Examples of the above-mentioned additive include: a tackifier; a softening agent; an antioxidant; a hindered amine-based light stabilizer; a UV absorbing agent; and a filler or pigment such as calcium oxide, magnesium oxide, silica, zinc oxide, or titanium oxide.

The compounding of the tackifier is effective in improving an adhesive strength. The compounding amount of the tackifier is suitably determined to be any appropriate compounding amount depending on an adherend in order that the emergence of an adhesive residue problem due to a reduction in cohesive strength may be avoided. In ordinary cases, the amount is preferably 0 to 40 parts by weight, more preferably 0 to 30 parts by weight, or still more preferably 0 to 10 parts by weight with respect to 100 parts by weight of the resin material of which the pressure-sensitive adhesive is formed.

Examples of the tackifier include: petroleum-based resins such as an aliphatic copolymer, an aromatic copolymer, an aliphatic/aromatic copolymer system, and an alicyclic copolymer; rosin-based resins such as a coumarone-indene-based resin, a terpene-based resin, a terpene phenol-based resin, and polymerized rosin; (alkyl) phenol-based resins; xylene-based resins; and hydrogenated products of the resins. One kind of the tackifiers may be used alone, or two or more kinds of them may be used in combination.

A hydrogenated tackifier such as an “ARKON P-125” manufactured by Arakawa Chemical Industries, Ltd. is preferably used as the tackifier in terms of, for example, releasability and weatherability. It should be noted that a product commercially available as a blend with an olefin resin or thermoplastic elastomer can also be used as the tackifier.

The compounding of the softening agent is effective in improving the adhesive strength. Examples of the softening agent include a low-molecular-weight diene-based polymer, a polyisobutylene, a hydrogenated polyisoprene, a hydrogenated polybutadiene, and derivatives of them. Examples of the derivatives include those each having an OH group or COOH group on one of, or each of both of, its terminals. Specific examples of such derivatives include a hydrogenated polybutadiene diol, a hydrogenated polybutadiene monool, a hydrogenated polyisoprene diol, and a hydrogenated polyisoprene monool. A hydrogenated product of a diene-based polymer such as a hydrogenated polybutadiene or a hydrogenated polyisoprene, an olefin-based softening agent, or the like is preferred in order that a rise in adhesion for the adherend may be additionally suppressed. To be specific, a “Kuraprene LIR-200” manufactured by KURARAY CO., LTD. is exemplified. One kind of those softening agents may be used alone, or two or more kinds of them may be used in combination.

The molecular weight of the softening agent can be suitably set to any appropriate value. When the molecular weight of the softening agent is excessively small, the small molecular weight may cause, for example, the transfer of a substance from the pressure-sensitive adhesive layer to the adherend or heavy release. On the other hand, when the molecular weight of the softening agent is excessively large, an improving effect on the adhesive strength tends to be poor. Accordingly, the number-average molecular weight of the softening agent is preferably 5000 to 100,000, or more preferably 10,000 to 50,000.

When the softening agent is used, any appropriate amount can be adopted as its addition amount. When the addition amount of the softening agent is excessively large, the amount of an adhesive residue at the time of exposure to high temperatures or outdoors tends to increase. Accordingly, the addition amount is preferably 40 parts by weight or less, more preferably 20 parts by weight or less, or still more preferably 10 parts by weight or less with respect to 100 parts by weight of the resin material of which the pressure-sensitive adhesive is formed. When the addition amount of the softening agent exceeds 40 parts by weight with respect to 100 parts by weight of the resin material of which the pressure-sensitive adhesive is formed, the adhesive residue under a high-temperature environment or under exposure to outdoors becomes remarkable.

One, or each of both, of the surfaces of the above-mentioned pressure-sensitive adhesive layer may be subjected to a surface treatment as required. Examples of the surface treatment include a corona discharge treatment, a UV irradiation treatment, a flame treatment, a plasma treatment, and a sputter etching treatment.

### B-2. Method of Producing Pressure-Sensitive Adhesive Tape

The pressure-sensitive adhesive tape of the present invention can be obtained by any appropriate production method. Examples of the production method for the pressure-sensitive adhesive tape of the present invention include: a method involving subjecting the above-mentioned base material layer and the above-mentioned surface layer of which the laminated film of the present invention is constituted, and the above-mentioned pressure-sensitive adhesive layer to co-extrusion (production method 1); a method involving performing the hot-melt application of the above-mentioned pressure-sensitive adhesive onto the side of the above-mentioned laminated film where the above-mentioned surface layer is not placed (production method 2); and a method involving applying an organic solvent application liquid in which the pressure-sensitive adhesive is dissolved or an emulsion liquid in which the pressure-sensitive adhesive is water-dispersed onto the side of the above-mentioned laminated film where the above-mentioned surface layer is not placed (production method 3). It should be noted that the laminated film in each of the production methods 2 and 3 can be obtained by the method described in the section A-3.

When the pressure-sensitive adhesive tape is produced by the above-mentioned production method 1 or 2, the above-mentioned thermoplastic pressure-sensitive adhesive is preferably used as the pressure-sensitive adhesive of which the pressure-sensitive adhesive layer is constituted.

A method for the above-mentioned co-extrusion in the above-mentioned production method 1 can be performed with an extruder and a co-extrusion die for the respective materials of which the base material layer, the surface layer, and the pressure-sensitive adhesive layer are formed in conformity with, for example, an inflation method or a T-die method.

When the pressure-sensitive adhesive tape is produced by the above-mentioned production method 2 or 3, the surface onto which the pressure-sensitive adhesive is applied, that is, the surface on the side of the above-mentioned laminated film where the above-mentioned surface layer is not placed is preferably subjected to an easy-adhesion treatment. Examples of the easy-adhesion treatment include a corona discharge treatment, an ITRO treatment (silicification flame treatment), and an anchor coat treatment.

When the pressure-sensitive adhesive tape is produced by the above-mentioned production method 3, the above-mentioned rubber-based pressure-sensitive adhesive, acrylic pressure-sensitive adhesive, or silicone-based pressure-sensitive adhesive is preferably used as the pressure-sensitive adhesive of which the above-mentioned pressure-sensitive adhesive layer is constituted.

When the pressure-sensitive adhesive tape is produced by the above-mentioned production method 3, any appropriate solvent can be adopted as the above-mentioned organic solvent. Examples of the above-mentioned organic solvent include: aromatic hydrocarbon-based solvents such as toluene and xylene; aliphatic carboxylate-based solvents such as ethyl acetate; and aliphatic hydrocarbon-based solvents such as hexane, heptane, and octane. One kind of the above-mentioned organic solvents may be used alone, or two or more kinds of them may be used in combination.

When the pressure-sensitive adhesive tape is produced by the above-mentioned production method 3, a cross-linking agent may be incorporated into the organic solvent application liquid. Examples of the cross-linking agent include an epoxy-based cross-linking agent, an isocyanate-based cross-linking agent, and an aziridine cross-linking agent.

Any appropriate application method can be adopted as an application method when the pressure-sensitive adhesive tape is produced by the above-mentioned production method 3. Examples of the application method include methods each involving the use of a bar coater, a gravure coater, a spin coater, a roll coater, a knife coater, or an applicator.

### Examples

Hereinafter, the present invention is specifically described by way of examples. However, the present invention is by no means limited by these examples. It should be noted that, in the examples and the like, test and evaluation methods are as described below, and the term “part(s)” means “part(s) by weight.”

### (1) Image Clarity

Measurement was performed with an “ICM-1” manufactured by Suga Test Instruments Co., Ltd. in conformity with JIS K7105 and a transmission-type optical comb of 2 mm. It should be noted that an image clarity in a lengthwise direction was measured so that the lengthwise direction of a laminated film or pressure-sensitive adhesive tape and the line direction of the transmission portion of the optical comb might be parallel to each other. An image clarity in a widthwise direction was measured so that the lengthwise direction of the laminated film or pressure-sensitive adhesive tape and the line direction of the transmission portion of the optical comb might be perpendicular to each other. The image clarity is calculated from the equation “image clarity (%)=(M−m)/(M+m)×100 (M: highest wave height, m: lowest wave height).”

### (2) Arithmetic Average Surface Roughness Ra

After a laminated film or a pressure-sensitive adhesive tape had been attached to a slide glass, the surface roughness of its surface layer was measured with an optical profiler NT9100 (manufactured by Veeco) under the conditions “Measurement Type: VSI (Infinite Scan), Objective: 2.5×, FOV: 1.0×, Modulation Threshold: 0.1%” for n=3. After the measurement, data analysis was performed under the conditions “Terms Removal: Tilt Only (Plane Fit), Window Filtering : None.” Thus, the arithmetic average surface roughness Ra was determined.

### (3) Haze Value

Measurement was performed with a HAZEMETER HM-150 (manufactured by Murakami Color Research Laboratory Co., Ltd.). The haze was calculated in conformity with JIS K7136 from the equation “haze (%)=Td/Tt×100 (Td: diffuse transmittance, Tt: total light transmittance).”

### Example 1

The following compounds were prepared as a surface layer-forming material, a base material layer-forming material, and a smooth layer-forming material.

Surface layer-forming material: A mixture of 50 parts of a low-density polyethylene (Petrocene 209 manufactured by TOSOH CORPORATION; melt flow rate (MFR)=45 (190° C., 2.16 kgf)) and 50 parts of an ethylene-vinyl acetate copolymer (EVAFLEX EV270 manufactured by DUPONT-MITSUI POLYCHEMICALS CO., LTD.; MFR=1.0 (190° C., 2.16 kgf); vinyl acetate (VA) content=28 wt %)

Base material layer-forming material: A block polypropylene (PF380A manufactured by SunAllomer Ltd.)

Smooth layer-forming material: A low-density polyethylene (NOVATEC LD LC720 manufactured by Japan Polyethylene Corporation)

The above-mentioned materials were molded by T-die melt co-extrusion. Thus, a laminated film (1) including the surface layer, the base material layer, and the smooth layer in the stated order was obtained. The surface layer had a thickness of 2 μm, the base material layer had a thickness of 38 μm, and the smooth layer had a thickness of 7 μm. Table 1 shows the results of the evaluation of the resultant laminated film (1).

### Example 2

A laminated film (2) was obtained in the same manner as in Example 1 except that a mixture of 80 parts of the low-density polyethylene (Petrocene 209 manufactured by TOSOH CORPORATION) and 20 parts of the ethylene-vinyl acetate copolymer (EVAFLEX EV270 manufactured by DUPONT-MITSUI POLYCHEMICALS CO., LTD.) was used instead of the mixture of 50 parts of the low-density polyethylene (Petrocene 209 manufactured by TOSOH CORPORATION) and 50 parts of the ethylene-vinyl acetate copolymer (EVAFLEX EV270 manufactured by DUPONT-MITSUI POLYCHEMICALS CO., LTD.) as the surface layer-forming material. The surface layer had a thickness of 2 μm, the base material layer had a thickness of 38 μm, and the smooth layer had a thickness of 7 μm. Table 1 shows the results of the evaluation of the resultant laminated film (2).

### Example 3

A laminated film (3) was obtained in the same manner as in Example 1 except that a mixture of 70 parts of the low-density polyethylene (Petrocene 209 manufactured by TOSOH CORPORATION) and 30 parts of the ethylene-vinyl acetate copolymer (EVAFLEX EV270 manufactured by DUPONT-MITSUI POLYCHEMICALS CO., LTD.) was used instead of the mixture of 50 parts of the low-density polyethylene (Petrocene 209 manufactured by TOSOH CORPORATION) and 50 parts of the ethylene-vinyl acetate copolymer (EVAFLEX EV270 manufactured by DUPONT-MITSUI POLYCHEMICALS CO., LTD.) as the surface layer-forming material. The surface layer had a thickness of 2 μm, the base material layer had a thickness of 38 μm, and the smooth layer had a thickness of 7 μm. Table 1 shows the results of the evaluation of the resultant laminated film (3).

### Example 4

A laminated film (4) was obtained in the same manner as in Example 1 except that a mixture of 60 parts of the low-density polyethylene (Petrocene 209 manufactured by TOSOH CORPORATION) and 40 parts of the ethylene-vinyl acetate copolymer (EVAFLEX EV270 manufactured by DUPONT-MITSUI POLYCHEMICALS CO., LTD.) was used instead of the mixture of 50 parts of the low-density polyethylene (Petrocene 209 manufactured by TOSOH CORPORATION) and 50 parts of the ethylene-vinyl acetate copolymer (EVAFLEX EV270 manufactured by DUPONT-MITSUI POLYCHEMICALS CO., LTD.) as the surface layer-forming material. The surface layer had a thickness of 2 μm, the base material layer had a thickness of 38 μm, and the smooth layer had a thickness of 7 μm. Table 1 shows the results of the evaluation of the resultant laminated film (4).

### Example 5

A laminated film (5) was obtained in the same manner as in Example 1 except that 50 parts of a low-density polyethylene (NOVATEC LD LJ803 manufactured by Japan Polyethylene Corporation; MFR=22 (190° C., 2.16 kgf)) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the smooth layer had a thickness of 7 μm. Table 1 shows the results of the evaluation of the resultant laminated film (5).

### Example 6

The following compounds were prepared as a surface layer-forming material, a base material layer-forming material, and a pressure-sensitive adhesive layer-forming material.

Surface layer-forming material: A mixture of 50 parts of a low-density polyethylene (Petrocene 209 manufactured by TOSOH CORPORATION), 50 parts of an ethylene-vinyl acetate copolymer (EVAFLEX EV270 manufactured by DUPONT-MITSUI POLYCHEMICALS CO., LTD.), and 10 parts of a long-chain alkyl-based releasing agent (Ashioresin RA95HS (completely saponified polyvinyl octadecyl carbamate-based releasing agent) manufactured by Ashio Co., Ltd.)

Base material layer-forming material: A block polypropylene (PF380A manufactured by SunAllomer Ltd.)

Pressure-sensitive adhesive layer-forming material: A mixture of 75 parts of a styrene-ethylene-butylene-styrene block copolymer (SEBS) (G1657 manufactured by Kraton Polymers) and 25 parts of a tackifier (ARKON P-125 manufactured by Arakawa Chemical Industries, Ltd.)

The above-mentioned materials were molded by T-die melt co-extrusion. Thus, a pressure-sensitive adhesive tape (1) including the surface layer, the base material layer, and the pressure-sensitive adhesive layer in the stated order was obtained. The surface layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (1).

### Example 7

A pressure-sensitive adhesive tape (2) was obtained in the same manner as in Example 6 except that 80 parts of the low-density polyethylene (Petrocene 209 manufactured by TOSOH CORPORATION) were used instead of 50 parts of the low-density polyethylene (Petrocene 209 manufactured by TOSOH CORPORATION), and 20 parts of the ethylene-vinyl acetate copolymer (EVAFLEX EV270 manufactured by DUPONT-MITSUI POLYCHEMICALS CO., LTD.) were used instead of 50 parts of the ethylene-vinyl acetate copolymer (EVAFLEX EV270 manufactured by DUPONT-MITSUI POLYCHEMICALS CO., LTD.) in the surface layer-forming material. The surface layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (2).

### Example 8

A pressure-sensitive adhesive tape (3) was obtained in the same manner as in Example 6 except that 70 parts of the low-density polyethylene (Petrocene 209 manufactured by TOSOH CORPORATION) were used instead of 50 parts of the low-density polyethylene (Petrocene 209 manufactured by TOSOH CORPORATION), and 30 parts of the ethylene-vinyl acetate copolymer (EVAFLEX EV270 manufactured by DUPONT-MITSUI POLYCHEMICALS CO., LTD.) were used instead of 50 parts of the ethylene-vinyl acetate copolymer (EVAFLEX EV270 manufactured by DUPONT-MITSUI POLYCHEMICALS CO., LTD.) in the surface layer-forming material. The surface layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (3).

### Example 9

A pressure-sensitive adhesive tape (4) was obtained in the same manner as in Example 6 except that 60 parts of the low-density polyethylene (Petrocene 209 manufactured by TOSOH CORPORATION) were used instead of 50 parts of the low-density polyethylene (Petrocene 209 manufactured by TOSOH CORPORATION), and 40 parts of the ethylene-vinyl acetate copolymer (EVAFLEX EV270 manufactured by DUPONT-MITSUI POLYCHEMICALS CO., LTD.) were used instead of 50 parts of the ethylene-vinyl acetate copolymer (EVAFLEX EV270 manufactured by DUPONT-MITSUI POLYCHEMICALS CO., LTD.) in the surface layer-forming material. The surface layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (4).

### Example 10

A pressure-sensitive adhesive tape (5) was obtained in the same manner as in Example 6 except that 50 parts of the low-density polyethylene (NOVATEC LD LJ803 manufactured by Japan Polyethylene Corporation) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (5).

### Comparative Example 1

A laminated film (C1) was obtained in the same manner as in Example 1 except that a mixture of 10 parts of the low-density polyethylene (Petrocene 209 manufactured by TOSOH CORPORATION) and 90 parts of the ethylene-vinyl acetate copolymer (EVAFLEX EV270 manufactured by DUPONT-MITSUI POLYCHEMICALS CO., LTD.) was used instead of the mixture of 50 parts of the low-density polyethylene (Petrocene 209 manufactured by TOSOH CORPORATION) and 50 parts of the ethylene-vinyl acetate copolymer (EVAFLEX EV270 manufactured by DUPONT-MITSUI POLYCHEMICALS CO., LTD.) as the surface layer-forming material. The surface layer had a thickness of 2 μm, the base material layer had a thickness of 38 μm, and the smooth layer had a thickness of 7 μm. Table 1 shows the results of the evaluation of the resultant laminated film (C1).

### Comparative Example 2

A laminated film (C2) was obtained in the same manner as in Example 1 except that 50 parts of the low-density polyethylene (NOVATEC LD LC720 manufactured by Japan Polyethylene Corporation; MFR=9.4 (190° C., 2.16 kgf)) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the smooth layer had a thickness of 7 μm. Table 1 shows the results of the evaluation of the resultant laminated film (C2).

### Comparative Example 3

A laminated film (C3) was obtained in the same manner as in Example 1 except that 50 parts of a low-density polyethylene (Petrocene 217 manufactured by TOSOH CORPORATION; MFR=4.5 (190° C., 2.16 kgf)) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the smooth layer had a thickness of 7 μm. Table 1 shows the results of the evaluation of the resultant laminated film (C3).

### Comparative Example 4

A laminated film (C4) was obtained in the same manner as in Example 1 except that 50 parts of a low-density polyethylene (NOVATEC LD LC701 manufactured by Japan Polyethylene Corporation; MFR=14 (190° C., 2.16 kgf)) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the smooth layer had a thickness of 7 μm. Table 1 shows the results of the evaluation of the resultant laminated film (C4).

### Comparative Example 5

A laminated film (C5) was obtained in the same manner as in Example 1 except that a mixture of 50 parts of the low-density polyethylene (NOVATEC LD LC720 manufactured by Japan Polyethylene Corporation) and 50 parts of an ethylene-vinyl acetate copolymer (NOVATEC EVA LV211 manufactured by Japan Polyethylene Corporation; MFR=0.3 (190° C., 2.16 kgf); VA content=6 wt %) was used instead of the mixture of 50 parts of the low-density polyethylene (Petrocene 209 manufactured by TOSOH CORPORATION) and 50 parts of the ethylene-vinyl acetate copolymer (EVAFLEX EV270 manufactured by DUPONT-MITSUI POLYCHEMICALS CO., LTD.) as the surface layer-forming material. The surface layer had a thickness of 2 μm, the base material layer had a thickness of 38 μm, and the smooth layer had a thickness of 7 μm. Table 1 shows the results of the evaluation of the resultant laminated film (C5).

### Comparative Example 6

A laminated film (C6) was obtained in the same manner as in Example 1 except that a mixture of 50 parts of the low-density polyethylene (NOVATEC LD LC 720 manufactured by Japan Polyethylene Corporation) and 50 parts of an ethylene-vinyl acetate copolymer (Ultracene 627 manufactured by TOSOH CORPORATION; MFR=0.8 (190° C., 2.16 kgf); VA content=20 wt %) was used instead of the mixture of 50 parts of the low-density polyethylene (Petrocene 209 manufactured by TOSOH CORPORATION) and 50 parts of the ethylene-vinyl acetate copolymer (EVAFLEX EV270 manufactured by DUPONT-MITSUI POLYCHEMICALS CO., LTD.) as the surface layer-forming material. The surface layer had a thickness of 2 μm, the base material layer had a thickness of 38 μm, and the smooth layer had a thickness of 7 μm. Table 1 shows the results of the evaluation of the resultant laminated film (C6).

### Comparative Example 7

A laminated film (C7) was obtained in the same manner as in Example 1 except that the ethylene-vinyl acetate copolymer was not used in the surface layer-forming material. The surface layer had a thickness of 2 μm, the base material layer had a thickness of 38 μm, and the smooth layer had a thickness of 7 μm. Table 1 shows the results of the evaluation of the resultant laminated film (C7).

### Comparative Example 8

A pressure-sensitive adhesive tape (C1) was obtained in the same manner as in Example 6 except that 10 parts of the low-density polyethylene (Petrocene 209 manufactured by TOSOH CORPORATION) were used instead of 50 parts of the low-density polyethylene (Petrocene 209 manufactured by TOSOH CORPORATION), and 90 parts of the ethylene-vinyl acetate copolymer (EVAFLEX EV270 manufactured by DUPONT-MITSUI POLYCHEMICALS CO., LTD.) were used instead of 50 parts of the ethylene-vinyl acetate copolymer (EVAFLEX EV270 manufactured by DUPONT-MITSUI POLYCHEMICALS CO., LTD.) in the surface layer-forming material. The surface layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (C1).

### Comparative Example 9

A pressure-sensitive adhesive tape (C2) was obtained in the same manner as in Example 6 except that 50 parts of the low-density polyethylene (NOVATEC LD LC720 manufactured by Japan Polyethylene Corporation) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (C2).

### Comparative Example 10

A pressure-sensitive adhesive tape (C3) was obtained in the same manner as in Example 6 except that 50 parts of the low-density polyethylene (Petrocene 217 manufactured by TOSOH CORPORATION) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (C3).

### Comparative Example 11

A pressure-sensitive adhesive tape (C4) was obtained in the same manner as in Example 6 except that 50 parts of the low-density polyethylene (NOVATEC LD LC720 manufactured by Japan Polyethylene Corporation) were used instead of 50 parts of the low-density polyethylene (Petrocene 209 manufactured by TOSOH CORPORATION), and 50 parts of the ethylene-vinyl acetate copolymer (NOVATEC EVA LV211 manufactured by Japan Polyethylene Corporation) were used instead of 50 parts of the ethylene-vinyl acetate copolymer (EVAFLEX EV270 manufactured by DUPONT-MITSUI POLYCHEMICALS CO., LTD.) in the surface layer-forming material. The surface layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (C4).

### Comparative Example 12

A pressure-sensitive adhesive tape (C5) was obtained in the same manner as in Example 6 except that the ethylene-vinyl acetate copolymer was not used in the surface layer-forming material. The surface layer had a thickness of 2 μm, the base material layer had a thickness of 38 μm, and the pressure-sensitive adhesive layer had a thickness of 7 μm. Table 2 shows the results of the evaluation of the resultant pressure-sensitive adhesive tape (C5).

TABLE 1

| | | | | | | | | Comparative |
|---|---|---|---|---|---|---|---|---|
| | | | Example 1 | Example 2 | Example 3 | Example 4 | Example 5 | Example 1 |
| Surface | Low-density | Trade name | Petrocene | Petrocene | Petrocene | Petrocene | NOVATEC | Petrocene |
| layer | polyethylene | | 209 | 209 | 209 | 209 | LD LJ803 | 209 |
| | | MFR | 45 | 45 | 45 | 45 | 22 | 45 |
| | | (g/10 min) | | | | | | |
| | Ethylene- | Trade name | EVAFLEX | EVAFLEX | EVAFLEX | EVAFLEX | EVAFLEX | EVAFLEX |
| | vinyl | | EV270 | EV270 | EV270 | EV270 | EV270 | EV270 |
| | acetate | MFR | 1.0 | 1.0 | 1.0 | 1.0 | 1.0 | 1.0 |
| | copolymer | (g/10 min) | | | | | | |
| | | VA content (wt %) | 28 | 28 | 28 | 28 | 28 | 28 |
| | Low-density polyethylene:Ethylene- | | 50:50 | 80:20 | 70:30 | 60:40 | 50:50 | 10:90 |
| | vinyl acetate copolymer | | | | | | | |
| Smooth | | Trade name | NOVATEC LD LC720 | | | | | |
| layer | | | | | | | | |
| | | Image clarity | 5.9 | 6.3 | 4.6 | 5.0 | 5.6 | 65.1 |
| | | in lengthwise | | | | | | |
| | | direction (%) | | | | | | |
| | | Image clarity | 7.2 | 6.2 | 5.8 | 8.0 | 11.9 | 76.7 |
| | | in widthwise | | | | | | |
| | | direction (%) | | | | | | |
| | | Difference in | 1.3 | −0.1 | 1.2 | 3.0 | 6.3 | 11.6 |
| | | image clarity | | | | | | |
| | | [widthwise direction − | | | | | | |
| | | lengthwise direction] (%) | | | | | | |
| | | Haze value (%) | 60.7 | 51.6 | 65.6 | 66.8 | 50.1 | 11.0 |
| | | Arithmetic average | 1.59 | 0.86 | 1.36 | 1.83 | 1.17 | 0.29 |
| | | surface | | | | | | |
| | | roughness Ra (μm) | | | | | | |
| | | | Comparative | Comparative | Comparative | Comparative | Comparative | Comparative |
| | | | Example 2 | Example 3 | Example 4 | Example 5 | Example 6 | Example 7 |
| Surface | Low-density | Trade name | NOVATEC | Petrocene | NOVATEC | NOVATEC | NOVATEC | Petrocene |
| layer | polyethylene | | LD LC720 | 217 | LD LC701 | LD LC720 | LD LC720 | 209 |
| | | MFR | 9.4 | 4.5 | 14 | 9.4 | 9.4 | 45 |
| | | (g/10 min) | | | | | | |
| | Ethylene- | Trade name | EVAFLEX | EVAFLEX | EVAFLEX | NOVATEC | Ultracene | — |
| | vinyl | | EV270 | EV270 | EV270 | EVA LV211 | 627 | |
| | acetate | MFR | 1.0 | 1.0 | 1.0 | 0.3 | 0.8 | — |
| | copolymer | (g/10 min) | | | | | | |
| | | VA content (wt %) | 28 | 28 | 28 | 6 | 20 | — |

| | | | | | | |
|---|---|---|---|---|---|---|
| Low-density polyethylene:Ethylene- | 50:50 | 50:50 | 50:50 | 50:50 | 50:50 | 100:0 |
| vinyl acetate copolymer | | | | | | |

| | | |
|---|---|---|
| Smooth | Trade name | NOVATEC LD LC720 |
| layer | | |

| | | | | | | |
|---|---|---|---|---|---|---|
| Image clarity | 4.6 | 5.4 | 5.0 | 59.9 | 5.0 | 35.1 |
| in lengthwise | | | | | | |
| direction (%) | | | | | | |
| Image clarity | 59.4 | 72.0 | 42.0 | 78.7 | 57.2 | 64.3 |
| in widthwise | | | | | | |
| direction (%) | | | | | | |
| Difference in | 54.8 | 66.6 | 37.0 | 18.8 | 52.2 | 29.2 |
| image clarity | | | | | | |
| [widthwise direction − | | | | | | |
| lengthwise direction] (%) | | | | | | |
| Haze value (%) | 29.1 | 20.4 | 40.4 | 11.2 | 26.0 | 12.4 |
| Arithmetic average | 1.10 | 0.74 | 1.10 | 0.30 | 0.94 | 0.43 |
| surface | | | | | | |
| roughness Ra (μm) | | | | | | |

TABLE 2

| | | | | | | | | Comparative |
|---|---|---|---|---|---|---|---|---|
| | | | Example 6 | Example 7 | Example 8 | Example 9 | Example 10 | Example 8 |
| Surface | Low-density | Trade name | Petrocene | Petrocene | Petrocene | Petrocene | NOVATEC | Petrocene |
| layer | polyethylene | | 209 | 209 | 209 | 209 | LD LJ803 | 209 |
| | | MFR | 45 | 45 | 45 | 45 | 22 | 45 |
| | | (g/10 min) | | | | | | |
| | Ethylene- | Trade name | EVAFLEX | EVAFLEX | EVAFLEX | EVAFLEX | EVAFLEX | EVAFLEX |
| | vinyl | | EV270 | EV270 | EV270 | EV270 | EV270 | EV270 |
| | acetate | MFR | 1.0 | 1.0 | 1.0 | 1.0 | 1.0 | 1.0 |
| | copolymer | (g/10 min) | | | | | | |
| | | VA content (wt %) | 28 | 28 | 28 | 28 | 28 | 28 |

| | | | | | | |
|---|---|---|---|---|---|---|
| Low-density polyethylene:Ethylene- | 50:50 | 80:20 | 70:30 | 60:40 | 50:50 | 10:90 |
| vinyl acetate copolymer | | | | | | |

| | | |
|---|---|---|
| Pressure- | Trade name | G 1657 (75 parts) and ARKON P-125 (25 parts) |
| sensitive | | |
| adhesive | | |
| layer | | |

| | | | | | | |
|---|---|---|---|---|---|---|
| Image clarity in lengthwise | 5.4 | 6.5 | 5.1 | 5.2 | 6.0 | 62.7 |
| direction (%) | | | | | | |
| Image clarity in widthwise | 6.9 | 6.2 | 6.7 | 7.6 | 10.8 | 75.8 |
| direction (%) | | | | | | |
| Difference in image clarity | 1.5 | −0.3 | 1.6 | 2.4 | 4.8 | 13.1 |
| [widthwise direction − | | | | | | |
| lengthwise direction] (%) | | | | | | |
| Haze value (%) | 55.8 | 48.9 | 60.2 | 63.5 | 45.2 | 10.8 |
| Arithmetic average surface | 1.51 | 0.82 | 1.30 | 1.78 | 1.20 | 0.25 |
| roughness Ra (μm) | | | | | | |

| | | | Comparative | Comparative | Comparative | Comparative |
|---|---|---|---|---|---|---|
| | | | Example 9 | Example 10 | Example 11 | Example 12 |
| Surface | Low-density | Trade name | NOVATEC | Petrocene | NOVATEC | Petrocene |
| layer | polyethylene | | LD LC720 | 217 | LD LC720 | 209 |
| | | MFR | 9.4 | 4.5 | 9.4 | 45 |
| | | (g/10 min) | | | | |
| | Ethylene- | Trade name | EVAFLEX | EVAFLEX | NOVATEC | — |
| | vinyl | | EV270 | EV270 | EVA LV211 | |
| | acetate | MFR | 1.0 | 1.0 | 0.3 | — |
| | copolymer | (g/10 min) | | | | |
| | | VA content (wt %) | 28 | 28 | 6 | — |

| | | | | |
|---|---|---|---|---|
| Low-density polyethylene:Ethylene- | 50:50 | 50:50 | 50:50 | 100:0 |
| vinyl acetate copolymer | | | | |

| | | |
|---|---|---|
| Pressure- | Trade name | G 1657 (75 parts) and ARKON P-125 (25 parts) |
| sensitive | | |
| adhesive | | |
| layer | | |

| | | | | |
|---|---|---|---|---|
| Image clarity in lengthwise | 3.8 | 5.6 | 60.7 | 36.5 |
| direction (%) | | | | |
| Image clarity in widthwise | 60.8 | 74.0 | 77.9 | 67.6 |
| direction (%) | | | | |
| Difference in image clarity | 57.0 | 68.4 | 17.2 | 31.1 |
| [widthwise direction − | | | | |
| lengthwise direction] (%) | | | | |
| Haze value (%) | 24.7 | 15.9 | 10.5 | 10.4 |
| Arithmetic average surface | 0.98 | 0.70 | 0.29 | 0.40 |
| roughness Ra (μm) | | | | |

### Example 11

The following compounds were prepared as a surface layer-forming material, a base material layer-forming material, and a smooth layer-forming material.

Surface layer-forming material: A mixture of 50 parts of a random polypropylene (NOVATEC PP EG8 manufactured by Japan Polypropylene Corporation; melt flow rate (MFR)=0.8 (230° C., 2.16 kgf)) and 50 parts of a low-density polyethylene (Petrocene 209 manufactured by TOSOH CORPORATION; melt flow rate (MFR)=45 (190° C., 2.16 kgf))

Base material layer-forming material: A block polypropylene (PF380A manufactured by SunAllomer Ltd.)

Smooth layer-forming material: A low-density polyethylene (NOVATEC LD LC720 manufactured by Japan Polyethylene Corporation)

The above-mentioned materials were molded by T-die melt co-extrusion. Thus, a laminated film (6) including the surface layer, the base material layer, and the smooth layer in the stated order was obtained. The surface layer had a thickness of 2 μm, the base material layer had a thickness of 38 μm, and the smooth layer had a thickness of 7 μm. Table 3 shows the results of the evaluation of the resultant laminated film (6).

### Example 12

A laminated film (7) was obtained in the same manner as in Example 11 except that a mixture of 50 parts of the random polypropylene (NOVATEC PP EG8 manufactured by Japan Polypropylene Corporation; melt flow rate (MFR)=0.8 (230° C., 2.16 kgf)) and 50 parts of a low-density polyethylene (NOVATEC LD LJ803 manufactured by Japan Polyethylene Corporation; melt flow rate (MFR)=22 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (7).

### Example 13

A laminated film (8) was obtained in the same manner as in Example 11 except that a mixture of 10 parts of the random polypropylene (NOVATEC PP EG8 manufactured by Japan Polypropylene Corporation; melt flow rate (MFR)=0.8 (230° C., 2.16 kgf)) and 90 parts of a low-density polyethylene (Petrocene 209 manufactured by TOSOH CORPORATION; melt flow rate (MFR)=45 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (8).

### Example 14

A laminated film (9) was obtained in the same manner as in Example 11 except that a mixture of 20 parts of the random polypropylene (NOVATEC PP EG8 manufactured by Japan Polypropylene Corporation; melt flow rate (MFR)=0.8 (230° C., 2.16 kgf)) and 80 parts of a low-density polyethylene (Petrocene 209 manufactured by TOSOH CORPORATION; melt flow rate (MFR)=45 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (9).

### Example 15

A laminated film (10) was obtained in the same manner as in Example 11 except that a mixture of 30 parts of the random polypropylene (NOVATEC PP EG8 manufactured by Japan Polypropylene Corporation; melt flow rate (MFR)=0.8 (230° C., 2.16 kgf)) and 70 parts of a low-density polyethylene (Petrocene 209 manufactured by TOSOH CORPORATION; melt flow rate (MFR)=45 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (10).

### Example 16

A laminated film (11) was obtained in the same manner as in Example 11 except that a mixture of 40 parts of the random polypropylene (NOVATEC PP EG8 manufactured by Japan Polypropylene Corporation; melt flow rate (MFR)=0.8 (230° C., 2.16 kgf)) and 60 parts of a low-density polyethylene (Petrocene 209 manufactured by TOSOH CORPORATION; melt flow rate (MFR)=45 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (11).

### Example 17

The following compounds were prepared as a surface layer-forming material, a base material layer-forming material, and a pressure-sensitive adhesive layer-forming material.

Surface layer-forming material: A mixture of 50 parts of a random polypropylene (NOVATEC PP EG8 manufactured by Japan Polypropylene Corporation; melt flow rate (MFR)=0.8 (230° C., 2.16 kgf)), 50 parts of a low-density polyethylene (Petrocene 209 manufactured by TOSOH CORPORATION; melt flow rate (MFR)=45 (190° C., 2.16 kgf)), and 10 parts of a long-chain alkyl-based releasing agent (Ashioresin RA95HS (completely saponified polyvinyl octadecyl carbamate-based releasing agent) manufactured by Ashio Co., Ltd.)

Base material layer-forming material: A block polypropylene (PF380A manufactured by SunAllomer Ltd.)

Pressure-sensitive adhesive layer-forming material: A mixture of 75 parts of a styrene-ethylene-butylene-styrene block copolymer (SEBS) (G1657 manufactured by Kraton Polymers) and 25 parts of a tackifier (ARKON P-125 manufactured by Arakawa Chemical Industries, Ltd.)

The above-mentioned materials were molded by T-die melt co-extrusion. Thus, a pressure-sensitive adhesive tape (6) including the surface layer, the base material layer, and the pressure-sensitive adhesive layer in the stated order was obtained. The surface layer had a thickness of 2 μm, the base material layer had a thickness of 38 μm, and the pressure-sensitive adhesive layer had a thickness of 7 μm. Table 4 shows the results of the evaluation of the resultant pressure-sensitive adhesive tape (6).

### Example 18

A pressure-sensitive adhesive tape (7) was obtained in the same manner as in Example 17 except that 50 parts of the low-density polyethylene (NOVATEC LD LJ803 manufactured by Japan Polyethylene Corporation) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the pressure-sensitive adhesive layer had a thickness of 7 μm. Table 4 shows the results of the evaluation of the resultant pressure-sensitive adhesive tape (7).

### Example 19

A pressure-sensitive adhesive tape (8) was obtained in the same manner as in Example 17 except that a mixture of 10 parts of the random polypropylene (NOVATEC PP EG8 manufactured by Japan Polypropylene Corporation) and 90 parts of the low-density polyethylene (Petrocene 209 manufactured by TOSOH CORPORATION) was used instead of the mixture of 50 parts of the random polypropylene (NOVATEC PP EG8 manufactured by Japan Polypropylene Corporation) and 50 parts of the low-density polyethylene (Petrocene 209 manufactured by TOSOH CORPORATION) as the surface layer-forming material. The surface layer had a thickness of 2 μm, the base material layer had a thickness of 38 μm, and the pressure-sensitive adhesive layer had a thickness of 7 μm. Table 4 shows the results of the evaluation of the resultant pressure-sensitive adhesive tape (8).

### Example 20

A pressure-sensitive adhesive tape (9) was obtained in the same manner as in Example 17 except that a mixture of 20 parts of the random polypropylene (NOVATEC PP EG8 manufactured by Japan Polypropylene Corporation) and 80 parts of the low-density polyethylene (Petrocene 209 manufactured by TOSOH CORPORATION) was used instead of the mixture of 50 parts of the random polypropylene (NOVATEC PP EG8 manufactured by Japan Polypropylene Corporation) and 50 parts of the low-density polyethylene (Petrocene 209 manufactured by TOSOH CORPORATION) as the surface layer-forming material. The surface layer had a thickness of 2 μm, the base material layer had a thickness of 38 μm, and the pressure-sensitive adhesive layer had a thickness of 7 μm. Table 4 shows the results of the evaluation of the resultant pressure-sensitive adhesive tape (9).

### Example 21

A pressure-sensitive adhesive tape (10) was obtained in the same manner as in Example 17 except that a mixture of 40 parts of the random polypropylene (NOVATEC PP EG8 manufactured by Japan Polypropylene Corporation) and 60 parts of the low-density polyethylene (Petrocene 209 manufactured by TOSOH CORPORATION) was used instead of the mixture of 50 parts of the random polypropylene (NOVATEC PP EG8 manufactured by Japan Polypropylene Corporation) and 50 parts of the low-density polyethylene (Petrocene 209 manufactured by TOSOH CORPORATION) as the surface layer-forming material. The surface layer had a thickness of 2 μm, the base material layer had a thickness of 38 μm, and the pressure-sensitive adhesive layer had a thickness of 7 μm. Table 4 shows the results of the evaluation of the resultant pressure-sensitive adhesive tape (10).

### Comparative Example 13

A laminated film (C8) was obtained in the same manner as in Example 11 except that a mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 217 manufactured by TOSOH CORPORATION; melt flow rate (MFR)=4.5 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (C8).

### Comparative Example 14

A laminated film (C9) was obtained in the same manner as in Example 11 except that a mixture of 50 parts of a random polypropylene (PC630A manufactured by SunAllomer Ltd.; melt flow rate (MFR)=7.5 (230° C., 2.16 kgf)) and 50 parts of a low-density polyethylene (NOVATEC LD LC720 manufactured by Japan Polyethylene Corporation; melt flow rate (MFR)=9.4 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (C9).

### Comparative Example 15

A laminated film (C10) was obtained in the same manner as in Example 11 except that a mixture of 50 parts of a random polypropylene (PF433M manufactured by SunAllomer Ltd.; melt flow rate (MFR)=2.0 (230° C., 2.16 kgf)) and 50 parts of the low-density polyethylene (NOVATEC LD LC720 manufactured by Japan Polyethylene Corporation; melt flow rate (MFR)=9.4 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (C10).

### Comparative Example 16

A laminated film (C11) was obtained in the same manner as in Example 11 except that a mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (NOVATEC LD LC720 manufactured by Japan Polyethylene Corporation; melt flow rate (MFR)=9.4 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (C11).

### Comparative Example 17

A laminated film (C12) was obtained in the same manner as in Example 11 except that a mixture of 50 parts of a random polypropylene (PB222A manufactured by SunAllomer Ltd.; melt flow rate (MFR)=0.8 (230° C., 2.16 kgf)) and 50 parts of the low-density polyethylene (NOVATEC LD LC720 manufactured by Japan Polyethylene Corporation; melt flow rate (MFR)=9.4 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (C12).

### Comparative Example 18

A laminated film (C13) was obtained in the same manner as in Example 11 except that a mixture of 50 parts of the random polypropylene (NOVATEC PP EG8 manufactured by Japan Polypropylene Corporation; melt flow rate (MFR)=0.8 (230° C., 2.16 kgf)) and 50 parts of a low-density polyethylene (NOVATEC LD LC701 manufactured by Japan Polyethylene Corporation; melt flow rate (MFR)=14 (190° C., 2.16 kgf)) was used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (C13).

### Comparative Example 19

A laminated film (C14) was obtained in the same manner as in Example 11 except that 100 parts of the random polypropylene (NOVATEC PP EG8 manufactured by Japan Polypropylene Corporation; melt flow rate (MFR)=0.8 (230° C., 2.16 kgf)) were used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (C14).

### Comparative Example 20

A laminated film (C15) was obtained in the same manner as in Example 11 except that 100 parts of the low-density polyethylene (Petrocene 209 manufactured by TOSOH CORPORATION; melt flow rate (MFR)=45 (190° C., 2.16 kgf)) were used instead of the mixture of 50 parts of the random polypropylene (NOVATEC PP EG8 manufactured by Japan Polypropylene Corporation; melt flow rate (MFR)=0.8 (230° C., 2.16 kgf)) and 50 parts of the low-density polyethylene (Petrocene 209 manufactured by TOSOH CORPORATION; melt flow rate (MFR)=45 (190° C., 2.16 kgf)) as the surface layer-forming material. The surface layer had a thickness of 2 μm, the base material layer had a thickness of 38 μm, and the smooth layer had a thickness of 7 μm. Table 3 shows the results of the evaluation of the resultant laminated film (C15).

### Comparative Example 21

A pressure-sensitive adhesive tape (C6) was obtained in the same manner as in Example 17 except that 50 parts of the low-density polyethylene (Petrocene 217 manufactured by TOSOH CORPORATION) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the pressure-sensitive adhesive layer had a thickness of 7 μm. Table 4 shows the results of the evaluation of the resultant pressure-sensitive adhesive tape (C6).

### Comparative Example 22

A pressure-sensitive adhesive tape (C7) was obtained in the same manner as in Example 17 except that 50 parts of the random polypropylene (PC630A manufactured by SunAllomer Ltd.) were used instead of 50 parts of the random polypropylene (NOVATEC PP EG8 manufactured by Japan Polypropylene Corporation), and the low-density polyethylene (NOVATEC LD LC720 manufactured by Japan Polyethylene Corporation) was used instead of the low-density polyethylene (Petrocene 209 manufactured by TOSOH CORPORATION) in the surface layer-forming material. The surface layer had a thickness of 2 μm, the base material layer had a thickness of 38 μm, and the pressure-sensitive adhesive layer had a thickness of 7 μm. Table 4 shows the results of the evaluation of the resultant pressure-sensitive adhesive tape (C7).

### Comparative Example 23

A pressure-sensitive adhesive tape (C8) was obtained in the same manner as in Example 17 except that 50 parts of the low-density polyethylene (NOVATEC LD LC 720 manufactured by Japan Polyethylene Corporation) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the pressure-sensitive adhesive layer had a thickness of 7 μm. Table 4 shows the results of the evaluation of the resultant pressure-sensitive adhesive tape (C8).

### Comparative Example 24

A pressure-sensitive adhesive tape (C9) was obtained in the same manner as in Example 17 except that 50 parts of the low-density polyethylene (NOVATEC LD LC701 manufactured by Japan Polyethylene Corporation) were used instead of 50 parts of the low-density polyethylene (Petrocene 209 manufactured by TOSOH CORPORATION) in the surface layer-forming material. The surface layer had a thickness of 2 μm, the base material layer had a thickness of 38 μm, and the pressure-sensitive adhesive layer had a thickness of 7 μm. Table 4 shows the results of the evaluation of the resultant pressure-sensitive adhesive tape (C9).

TABLE 3

| | | | Example 11 | Example 12 | Example 13 | Example 14 | Example 15 |
|---|---|---|---|---|---|---|---|
| Surface | Polypropylene | Trade name | NOVATEC | NOVATEC | NOVATEC | NOVATEC | NOVATEC |
| layer | | | PP EG8 | PP EG8 | PP EG8 | PP EG8 | PP EG8 |
| | | MFR | 0.8 | 0.8 | 0.8 | 0.8 | 0.8 |
| | | (g/10 min) | | | | | |
| | Low-density | Trade name | Petrocene | NOVATEC | Petrocene | Petrocene | Petrocene |
| | polyethylene | | 209 | LD LJ803 | 209 | 209 | 209 |
| | | MFR | 42 | 22 | 45 | 45 | 45 |
| | | (g/10 min) | | | | | |
| | Polypropylene:Low-density polyethylene | | 50:50 | 50:50 | 10:90 | 20:80 | 30:70 |
| Smooth | | Trade name | NOVATEC LD LC720 | | | | |
| layer | | | | | | | |
| | | Image clarity in lengthwise | 5.6 | 5.8 | 6.7 | 5.7 | 4.9 |
| | | direction (%) | | | | | |
| | | Image clarity in widthwise | 4.7 | 4.7 | 10.9 | 11.4 | 5.0 |
| | | direction (%) | | | | | |
| | | Difference in image clarity | −0.9 | −1.1 | 4.2 | 5.7 | 0.1 |
| | | [widthwise direction − | | | | | |
| | | lengthwise direction] (%) | | | | | |
| | | Haze value (%) | 70.8 | 63.1 | 41.4 | 56.6 | 70.9 |
| | | Arithmetic average surface | 1.74 | 1.04 | 0.66 | 0.92 | 1.36 |
| | | roughness Ra (μm) | | | | | |
| | | | | Comparative | Comparative | Comparative | Comparative |
| | | | Example 16 | Example 13 | Example 14 | Example 15 | Example 16 |
| Surface | Polypropylene | Trade name | NOVATEC | NOVATEC | PC630A | PF433M | NOVATEC |
| layer | | | PP EG8 | PP EG8 | | | PP EG8 |
| | | MFR | 0.8 | 0.8 | 7.5 | 2.0 | 0.8 |
| | | (g/10 min) | | | | | |
| | Low-density | Trade name | Petrocene | Petrocene | NOVATEC | NOVATEC | NOVATEC |
| | polyethylene | | 209 | 217 | LD LC720 | LD LC720 | LD LC720 |
| | | MFR | 45 | 4.5 | 9.4 | 9.4 | 9.4 |
| | | (g/10 min) | | | | | |

| | | | | | |
|---|---|---|---|---|---|
| Polypropylene:Low-density polyethylene | 40:60 | 50:50 | 50:50 | 50:50 | 50:50 |

| | | |
|---|---|---|
| Smooth | Trade name | NOVATEC LD LC720 |
| layer | | |

| | | | | | |
|---|---|---|---|---|---|
| Image clarity in lengthwise | 5.2 | 4.7 | 18.7 | 20.1 | 5.0 |
| direction (%) | | | | | |
| Image clarity in widthwise | 6.8 | 62.2 | 81.7 | 83.0 | 33.0 |
| direction (%) | | | | | |
| Difference in image clarity | 1.6 | 57.5 | 63.0 | 62.9 | 28 |
| [widthwise direction − | | | | | |
| lengthwise direction] (%) | | | | | |
| Haze value (%) | 73.9 | 24.2 | 11.5 | 13.5 | 36.8 |
| Arithmetic average surface | 1.51 | 0.67 | 0.52 | 0.42 | 0.83 |
| roughness Ra (μm) | | | | | |

| | | | Comparative | Comparative | Comparative | Comparative |
|---|---|---|---|---|---|---|
| | | | Example 17 | Example 18 | Example 19 | Example 20 |
| Surface | Polypropylene | Trade name | PB222A | NOVATEC | NOVATEC | — |
| layer | | | | PP EG8 | PP EG8 | |
| | | MFR | 0.8 | 0.8 | 0.8 | — |
| | | (g/10 min) | | | | |
| | Low-density | Trade name | NOVATEC | NOVATEC | — | Petrocene |
| | polyethylene | | LD LC720 | LD LC701 | | 209 |
| | | MFR | 9.4 | 14 | — | 45 |
| | | (g/10 min) | | | | |

| | | | | |
|---|---|---|---|---|
| Polypropylene:Low-density polyethylene | 50:50 | 50:50 | 100:0 | 100:0 |

| | | |
|---|---|---|
| Smooth | Trade name | NOVATEC LD LC720 |
| layer | | |

| | | | | |
|---|---|---|---|---|
| Image clarity in lengthwise | 4.9 | 4.9 | 45.5 | 35.1 |
| direction (%) | | | | |
| Image clarity in widthwise | 50.9 | 42.7 | 75.2 | 64.3 |
| direction (%) | | | | |
| Difference in image clarity | 46 | 37.8 | 29.7 | 29.2 |
| [widthwise direction − | | | | |
| lengthwise direction] (%) | | | | |
| Haze value (%) | 33.9 | 41.2 | 13.0 | 12.4 |
| Arithmetic average surface | 0.76 | 0.86 | 0.72 | 0.43 |
| roughness Ra (μm) | | | | |

TABLE 4

| | | | Example 17 | Example 18 | Example 19 | Example 20 | Example 21 |
|---|---|---|---|---|---|---|---|
| Surface | Polypropylene | Trade name | NOVATEC | NOVATEC | NOVATEC | NOVATEC | NOVATEC |
| layer | | | PP EG8 | PP EG8 | PP EG8 | PP EG8 | PP EG8 |
| | | MFR | 0.8 | 0.8 | 0.8 | 0.8 | 0.8 |
| | | (g/10 min) | | | | | |
| | Low-density | Trade name | Petrocene | NOVATEC | Petrocene | Petrocene | Petrocene |
| | polyethylene | | 209 | LD LJ803 | 209 | 209 | 209 |
| | | MFR | 45 | 22 | 45 | 45 | 45 |
| | | (g/10 min) | | | | | |

| | | | | | |
|---|---|---|---|---|---|
| Polypropylene:Low-density polyethylene | 50:50 | 50:50 | 10:90 | 20:80 | 40:60 |

| | | |
|---|---|---|
| Pressure- | Trade name | G 1657 (75 parts) and ARKON P-125 (25 parts) |
| sensitive | | |
| adhesive | | |
| layer | | |

| | | | | | |
|---|---|---|---|---|---|
| Image clarity in lengthwise | 5.7 | 5.9 | 6.8 | 5.8 | 5.4 |
| direction (%) | | | | | |
| Image clarity in widthwise | 4.8 | 4.9 | 10.5 | 10.6 | 6.6 |
| direction (%) | | | | | |
| Difference in image clarity | −0.9 | −1.0 | 3.7 | 4.8 | 1.2 |
| [widthwise direction − | | | | | |
| lengthwise direction] (%) | | | | | |
| Haze value (%) | 65.8 | 60.3 | 40.2 | 51.4 | 70.4 |
| Arithmetic average surface | 1.70 | 1.01 | 0.63 | 0.90 | 1.53 |
| roughness Ra (μm) | | | | | |

| | | | Comparative | Comparative | Comparative | Comparative |
|---|---|---|---|---|---|---|
| | | | Example 21 | Example 22 | Example 23 | Example 24 |
| Surface | Polypropylene | Trade name | NOVATEC | PC630A | NOVATEC | NOVATEC |
| layer | | | PP EG8 | | PP EG8 | PP EG8 |
| | | MFR | 0.8 | 7.5 | 0.8 | 0.8 |
| | | (g/10 min) | | | | |
| | Low-density | Trade name | Petrocene | NOVATEC | NOVATEC | NOVATEC |
| | polyethylene | | 217 | LD LC720 | LD LC720 | LD LC701 |
| | | MFR | 4.5 | 9.4 | 9.4 | 14 |
| | | (g/10 min) | | | | |

| | | | | |
|---|---|---|---|---|
| Polypropylene:Low-density polyethylene | 50:50 | 50:50 | 50:50 | 50:50 |

| | | |
|---|---|---|
| Pressure- | Trade name | G 1657 (75 parts) and ARKON P-125 (25 parts) |
| sensitive | | |
| adhesive | | |
| layer | | |

| | | | | |
|---|---|---|---|---|
| Image clarity in lengthwise | 4.9 | 19.6 | 4.8 | 4.6 |
| direction (%) | | | | |
| Image clarity in widthwise | 65.4 | 82.5 | 35.1 | 43.7 |
| direction (%) | | | | |
| Difference in image clarity | 60.5 | 62.9 | 30.3 | 39.1 |
| [widthwise direction − | | | | |
| lengthwise direction] (%) | | | | |
| Haze value (%) | 20.3 | 10.8 | 31.3 | 35.7 |
| Arithmetic average surface | 0.60 | 0.49 | 0.79 | 0.80 |
| roughness Ra (μm) | | | | |

As is apparent from Tables 1 to 4, each of the laminated film and pressure-sensitive adhesive tape of the present invention has a small absolute value of the difference between the image clarity in its lengthwise direction and the image clarity in its widthwise direction. In addition, the surface layer is so thin as not to affect the mechanical properties of the entire laminated film or pressure-sensitive adhesive tape.

### INDUSTRIAL APPLICABILITY

The laminated film and pressure-sensitive adhesive tape of the present invention can be widely used in applications for the production of electronic parts, for structures, for automobiles, and the like, such as a protecting application, an external appearance-adjusting application, a decorating application, and a labeling application.

### REFERENCE SIGNS LIST

1 base material layer
2 surface layer
10 laminated film
20 pressure-sensitive adhesive layer
100 pressure-sensitive adhesive tape

1. A laminated film, comprising:
a base material layer; and
a surface layer,
wherein:
the base material layer contains a thermoplastic resin; and
an absolute value of a difference between an image clarity in a lengthwise direction of the laminated film and an image clarity in a widthwise direction of the laminated film is 10% or less.

2. A laminated film according to claim 1, wherein the image clarity in the lengthwise direction is 20% or less, and the image clarity in the widthwise direction is 20% or less.

3. A laminated film according to claim 1, wherein the laminated film has a haze value of 30% to 80%.

4. A laminated film according to claim 1, wherein the surface layer has an arithmetic average surface roughness Ra of 0.5 μm to 2.0 μm.

5. A laminated film according to claim 1, wherein the surface layer has a thickness of 2 μm to 10 μm.

6. A laminated film according to claim 1, wherein the surface layer has two or more melting temperatures Tm in differential scanning calorimetry.

7. A laminated film according to claim 1, wherein the surface layer contains a polyethylene and an ethylene-vinyl acetate copolymer.

8. A laminated film according to claim 7, wherein a weight ratio between the polyethylene and the ethylene-vinyl acetate copolymer “polyethylene:ethylene-vinyl acetate copolymer” is 20:80 to 80:20.

9. A laminated film according to claim 7, wherein a content of a constituent unit derived from vinyl acetate in the ethylene-vinyl acetate copolymer is 10 wt % or more.

10. A laminated film according to claim 7, wherein the polyethylene has a melt flow rate of 8 g/10 min to 100 g/10 min.

11. A laminated film according to claim 7, wherein the ethylene-vinyl acetate copolymer has a melt flow rate of 0.1 g/10 min to 7 g/10 min.

12. A laminated film according to claim 1, wherein the surface layer contains a polyethylene and a propylene-based polymer.

13. A laminated film according to claim 12, wherein a weight ratio between the polyethylene and the propylene-based polymer “polyethylene:propylene-based polymer” is 10:90 to 90:10.

14. A laminated film according to claim 12, wherein the polyethylene has a melt flow rate of 8 g/10 min to 100 g/10 min.

15. A laminated film according to claim 12, wherein the propylene-based polymer has a melt flow rate of 0.1 g/10 min to 7 g/10 min.

16. A pressure-sensitive adhesive tape comprising a pressure-sensitive adhesive layer on one side of the laminated film according to claim 1.

17. A pressure-sensitive adhesive tape according to claim 16, wherein an absolute value of a difference between an image clarity in a lengthwise direction and an image clarity in a widthwise direction is 10% or less.

18. A pressure-sensitive adhesive tape according to claim 16, wherein an image clarity in a lengthwise direction is 20% or less, and an image clarity in a widthwise direction is 20% or less.

19. A pressure-sensitive adhesive tape according to claim 16, wherein the pressure-sensitive adhesive tape has a haze value of 30% to 80%.

20. A pressure-sensitive adhesive tape according to claim 16, wherein the surface layer has a long-chain alkyl-based releasing agent.
